(19) United States
(12) Patent Application Publication
(10) Pub. No.: US 2026/0145333 A1
(43) Pub. Date: May 28, 2026

(54) DEXTEROUS ARM-HAND GRASPING WITH GEOMETRIC FABRICS

(71) Applicant: NVIDIA Corporation, Santa Clara, CA (US)

(72) Inventors: Ritvik SINGH, San Jose, CA (US); Arthur ALLSHIRE, Toronto (CA); Ankur HANDA, Seattle, WA (US); Nathan Donald RATLIFF, Seattle, WA (US); Karl VAN WYK, Issaquah, WA (US)

(73) Assignee: NVIDIA Corporation, Santa Clara, CA (US)

(21) Appl. No.: 19/242,736

(22) Filed: Jun. 18, 2025

Related U.S. Application Data
(60) Provisional application No. 63/726,078, filed on Nov. 27, 2024.
(60) Provisional application No. 63/751,712, filed on Jan. 30, 2025.

(51) Int. Cl. B25J 9/16; B25J 13/08; G06T 7/50; G06T 7/70

(52) U.S. Cl. CPC B25J 9/1671; B25J 9/161; B25J 9/163; B25J 9/1669; B25J 13/089; G06T 7/50; G06T 7/70; G06T 2207/10028; G06T 2207/20081; G06T 2207/20084

(57) ABSTRACT

In various examples, systems and methods are disclosed relating to disclosed relating to dexterous arm-hand grasping with geometric fabrics. One or more processors can cause a teacher model to generate first actions for a geometric fabric associated with a simulated autonomous machine in a simulated environment using state information of the simulated environment and position information of a simulated object in the simulated environment. Using the teacher model and a depth image of the simulated environment, a student model can be updated to generate second actions for the geometric fabric associated with the simulated autonomous machine. A depth image of an environment can be provided as input to the student model to cause the student model to infer at least one action to control a physical autonomous machine with respect to a physical object using the geometric fabric.

### CROSS-REFERENCES TO RELATED APPLICATIONS

This application claims the benefit of and priority to U.S. Provisional Patent Application No. 63/726,078, filed Nov. 27, 2024, and claims the benefit of and priority to U.S. Provisional Patent Application No. 63/751,712, filed Jan. 30, 2025, the contents of which are incorporated herein by reference in their entirety for all purposes.

### BACKGROUND

Robotic systems may interact with and manipulate various objects to perform goal-based tasks. Manipulation tasks typically involve precise positioning, grasping, and movement of an object within a specific environment. However, reliably accomplishing such manipulation tasks can be challenging due to varying object configurations and dynamic environmental conditions.

### SUMMARY

This disclosure relates to systems and methods for implementing dexterous grasping with geometric fabrics. Such approaches can be implemented for automating tasks in robotics applications such as industrial manufacturing, bin packing, object transportation and storage, or other object manipulation tasks. Conventional approaches to dexterous grasping often exhibit limited operational speed or locations, restricted adaptability to diverse object geometries, or inadequate safety mechanisms. Existing systems fail to properly avoid collisions, manage high-dimensional observation-action spaces, and/or provide reliable hardware safety guarantees, thereby hindering consistent performance in real-world environments. Such shortcomings result in unsuccessful grasping attempts when encountering novel or irregularly shaped objects and increase risks of physical damage to both robotic components and manipulated items.

The techniques described herein address these shortcomings by providing a geometric fabric controller that implements dynamic and reactive dexterous grasping in real-world environments. The approaches described herein implement reinforcement learning and teacher-student distillation to train/update a machine-learning model that generates control instructions for precise object grasping. Reinforcement learning can be used to cause the model to learn grasping strategies through iterative trial and error, using the geometric fabric controller to impose constraints to guide the learning process. The geometric fabric controller can further establish an inductive bias for model learning. To implement these techniques, a teacher model with privileged information is first trained/updated in simulation and distilled into a depth-based student model, enabling zero-shot simulation-to-real transfer and improved performance on diverse physical objects.

In some implementations, the student model processes depth images or stereo RGB images, leveraging transformer layers to capture cross-attention across visual inputs and generate depth information. The trained/updated student model can operate in real-world environments by processing stereo camera captures of target objects and their surroundings. A state machine can be used to activate and/or deactivate predetermined inputs to the geometric fabric controller according to predicted object positions to facilitate execution of various object grasping/manipulation task for specific use-cases.

At least one aspect relates to one or more processors. The one or more processors can include one or more circuits. The one or more circuits can initialize a simulation comprising a simulated machine and a simulated object. The one or more circuits can cause a teacher model to generate first actions for a geometric fabric associated with a simulated autonomous machine (such as an autonomous or semi-autonomous robot, robotic platform or apparatus, vehicle, vessel, or other machine etc.) in a simulated environment using state information of the simulated environment and position information of a simulated object in the simulated environment. The one or more circuits can update, using the teacher model and a depth image of the simulated environment, a student model to generate second actions for the geometric fabric associated with the simulated autonomous machine. The one or more circuits can provide a depth image of an environment as input to the student model to cause the student model to infer at least one action to control a physical autonomous machine with respect to a physical object using the geometric fabric.

In some implementations, the one or more circuits can update the teacher model further based at least on one or more of simulated proprioception data of the autonomous machine in the simulated environment, a goal position for the object within the simulated environment, or one or more simulated forces applicable to the simulated environment. In some implementations, the one or more circuits can execute the simulated environment at a first update frequency. In some implementations, the one or more circuits can execute the teacher model to generate the first actions for the geometric fabric at a second update frequency. In some implementations, the one or more circuits can generate a control instruction for the autonomous machine by providing the at least one action as input to the geometric fabric. In some implementations, the one or more circuits can generate the control instruction based at least on a state machine.

In some implementations, the one or more circuits can update the student model based at least on a loss determined according to an output of the student model, an output of the teacher model, and state data of the simulated environment. In some implementations, the one or more circuits can update the teacher model further based at least on an output of a critic model generated using the state information of the simulated environment. In some implementations, the student model comprises one or more convolutional layers and one or more recurrent neural network (RNN) layers.

In some implementations, the one or more processors can execute a plurality of simulations of a plurality of simulated environments, each simulation comprising a respective simulated autonomous machine and a respective simulated object. In some implementations, the student model comprises one or more transformer layers. In some implementations, the student model comprises at least one RNN layer and at least one fully-connected layer. In some implementations, the one or more circuits can generate, during the second update phase, an auxiliary loss based at least on a predicted position of a simulated object generated by the student model and a ground-truth object position derived from the simulation.

At least one aspect relates to a system. The system can include a machine-such as an autonomous or semi-autonomous robot, robotic platform or apparatus, vehicle, vessel, or other machine-configured to operate in response to control instructions from a geometric fabric controller. The system can include one or more processors. The system can provide a depth image of an environment including the autonomous machine and a physical object as input to a machine-learning model to generate at least one action. The system can generate a set of control instructions for the autonomous machine using the geometric fabric controller and based at least on the at least one action. The system can control the machine using the set of control signals to grasp the object.

In some implementations, the system can generate an output action by providing the at least one action as input to a state machine. In some implementations, the system can generate the set of control signals based at least on providing the output action as input to the geometric fabric. In some implementations, the system can provide a set of proprioception data and the depth image as input to the machine-learning model to generate the at least one action. In some implementations, the system can provide an indication of a goal position as input to the machine-learning model. In some implementations, the system can generate, using the machine-learning model, an indication of a predicted position of the object. In some implementations, the system can generate the set of control instructions further based on the predicted position of the object.

At least one other aspect relates to a method. The method can be performed, for example, by one or more processors coupled to non-transitory memory. The method can include initializing a simulation comprising a simulated robot and a simulated object. The method can include updating a teacher model to generate first actions for a geometric fabric associated with a simulated autonomous machine of a simulation using state information of the simulation and position information of a simulated object in the simulation. The method can include updating, using the teacher model and a depth image of the simulation, a student model to generate second actions for the geometric fabric associated with the simulated autonomous machine. The method can include providing a depth image of an environment as input to the student model to predict at least one action to control a physical autonomous machine with respect to a physical object using the geometric fabric.

In some implementations, the method can include updating the teacher model further based at least on one or more of simulated proprioception data of the simulated autonomous machine in the simulation, a goal position for the object within the simulation, or simulated forces. In some implementations, the method can include executing the simulation at a first update frequency. In some implementations, the method can include executing the teacher model to generate the first actions for the geometric fabric at a second update frequency. In some implementations, the method can include generating a control instruction for the physical autonomous machine by providing the at least one action as input to the geometric fabric.

At least one aspect relates to one or more processors. The one or more processors can include one or more circuits. The one or more circuits can update, during a first update stage, a teacher model to generate first actions for a geometric fabric associated with a simulated autonomous machine of a simulation using state information of the simulation. The one or more circuits can update, during a second update stage, a student model to generate second actions for the geometric fabric using at least one rendered image of the simulation, the teacher model, and noised state information of the simulation. The one or more circuits can control, using the student model and the geometric fabric, a physical autonomous machine with respect to a physical object based at least on an image of an environment including the physical autonomous machine and the physical object.

In some implementations, the student model comprises one or more transformer layers. In some implementations, the student model comprises at least one RNN layer and at least one fully-connected layer. In some implementations, the one or more circuits can generate, during the second update phase, an auxiliary loss based at least on a predicted position of a simulated object generated by the student model and a ground-truth object position derived from the simulation. In some implementations, the one or more circuits can generate a loss for updating the student model based at least on the auxiliary loss and a second loss generated using an output of the teacher model.

In some implementations, the one or more circuits can update the student model further based on proprioception data derived from the simulation. In some implementations, the one or more circuits can execute the simulation at a frequency of about 120 Hertz. In some implementations, the one or more circuits can update the teacher model according to an automatic domain randomization function. In some implementations, the one or more circuits can modify lighting or materials of the simulation during the second update stage. In some implementations, the one or more circuits can update, during the second update stage, the student model to generate second actions for the geometric fabric using a plurality of rendered images of the simulation.

At least one aspect relates to a system. The system can include an autonomous machine configured to operate in response to control instructions from a geometric fabric controller. The system can include one or more processors. The system can capture at least two color-based images of an environment including the autonomous machine and a physical object. The system can provide the at least two color-based images as input to a machine-learning model comprising an encoder to implement cross-attention masking between the at least two color-based images, the machine-learning model generating at least one action for the autonomous machine. The system can control the autonomous machine with respect to the physical object using the at least one action and a geometric fabric controller.

In some implementations, the machine-learning model is to generate a predicted position of the object, and the system can control the autonomous machine further based on the predicted position of the object. In some implementations, the system can control the autonomous machine further based on an output of a state machine. In some implementations, the system can provide a set of proprioception data and the at least two color-based images as input to the machine-learning model to generate the at least one action. In some implementations, the machine-learning model further comprises at least one RNN layer and at least one fully connected layer.

At least one other aspect relates to a method. The method can be performed, for example, by one or more processors coupled to non-transitory memory. The method can include updating, during a first update stage, a teacher model to generate first actions for a geometric fabric associated with a simulated autonomous machine of a simulation using state information of the simulation. The method can include updating, during a second update stage, a student model to generate second actions for the geometric fabric using at least one rendered image of the simulation, the teacher model, and noised state information of the simulation. The method can further include controlling, using the student model and the geometric fabric, a physical autonomous machine with respect to a physical object based at least on an image of an environment including the physical autonomous machine and the physical object.

In some implementations, the student model comprises one or more transformer layers. In some implementations, the student model comprises at least one RNN layer and at least one fully-connected layer.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing dexterous grasping with geometric fabrics are described in detail below with reference to the attached drawing figures, wherein:

FIG. 1 depicts a block diagram of an example system for implementing dexterous grasping with geometric fabrics, in accordance with some embodiments of the present disclosure;

FIGS. 2A, 2B, and 2C depict block diagrams showing example data flows for training/updating and executing machine learning models for implementing dexterous grasping with geometric fabrics according to depth images, in accordance with some embodiments of the present disclosure;

FIGS. 3A, 3B, and 3C depict block diagrams showing example data flows for training/updating and executing machine learning models for implementing dexterous grasping with geometric fabrics according to red-green-blue (RGB) images, in accordance with some embodiments of the present disclosure;

FIG. 4 depicts a block diagram of an example architecture of a transformer model for stereo image processing to implement dexterous grasping with geometric fabrics according to RGB images, in accordance with some embodiments of the present disclosure;

FIG. 5 depicts a flow diagram of an example method for implementing dexterous grasping with geometric fabrics according to depth images, in accordance with some embodiments of the present disclosure;

FIG. 6 depicts a flow diagram of an example method for implementing dexterous grasping with geometric fabrics according to stereo RGB images, in accordance with some embodiments of the present disclosure;

FIG. 7A is an example of sensor locations having corresponding fields of view or sensory fields for example autonomous or semi-autonomous machines, in accordance with at least some embodiments of the present disclosure;

FIG. 7B is an illustration of an example of component and sensor locations on an autonomous or semi-autonomous vehicle, in accordance with at least some embodiments of the present disclosure;

FIG. 7C is a block diagram of an example system architecture for an autonomous or semi-autonomous vehicle, robot, and/or other machine type, in accordance with at least some embodiments of the present disclosure;

FIG. 7D is a block diagram of an example architecture of a computing system—such as a system-on-a-chip (SoC)—in accordance with at least some embodiments of the present disclosure;

FIG. 7E is a system diagram for communication between cloud-based server(s) and an example autonomous or semi-autonomous vehicle, robot, and/or other machine type, in accordance with at least some embodiments of the present disclosure;

FIG. 8 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 9 is a block diagram of an example computing system for generative artificial intelligence (AI), in accordance with at least some embodiments of the present disclosure; and

FIG. 10 is a block diagram of an example computing device, in accordance with at least some embodiments of the present disclosure.

### DETAILED DESCRIPTION

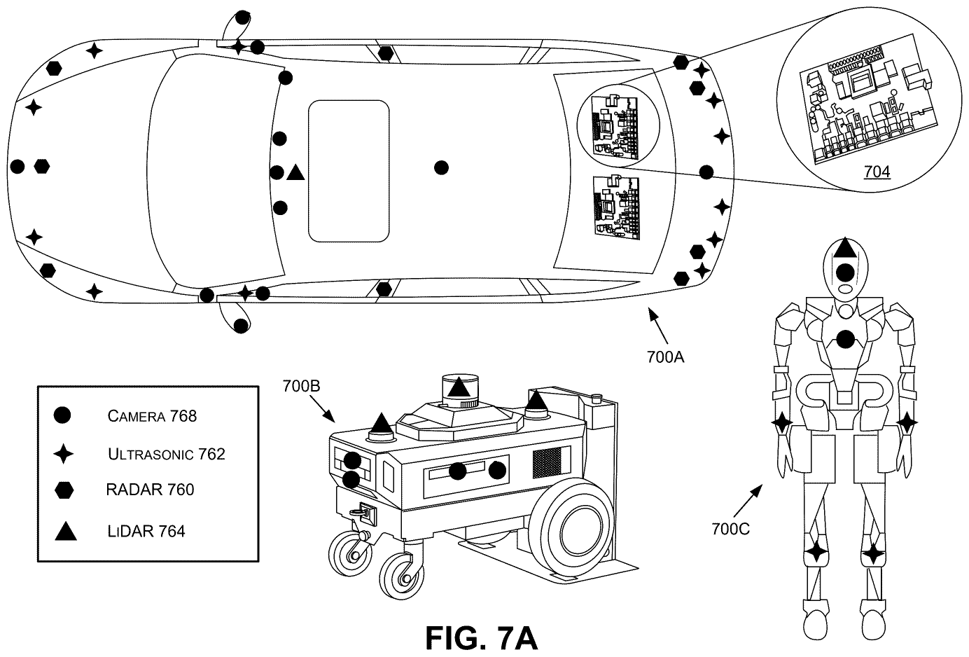

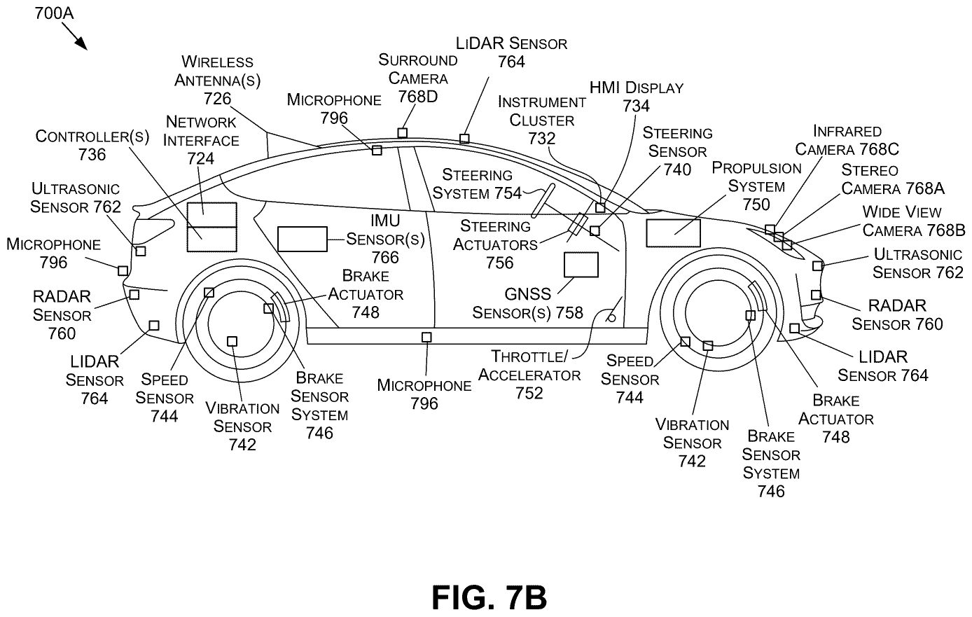

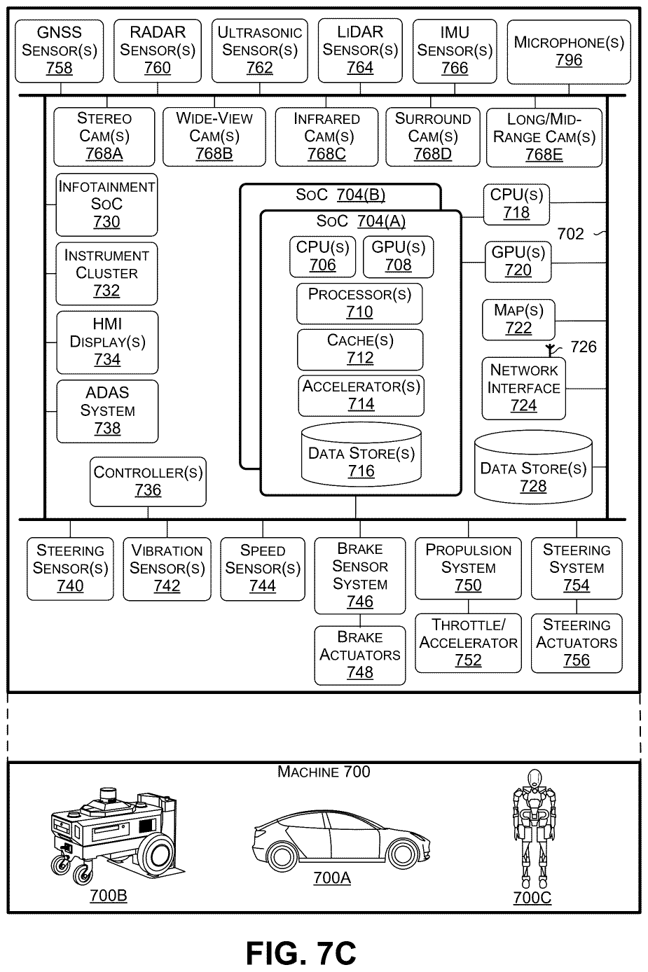

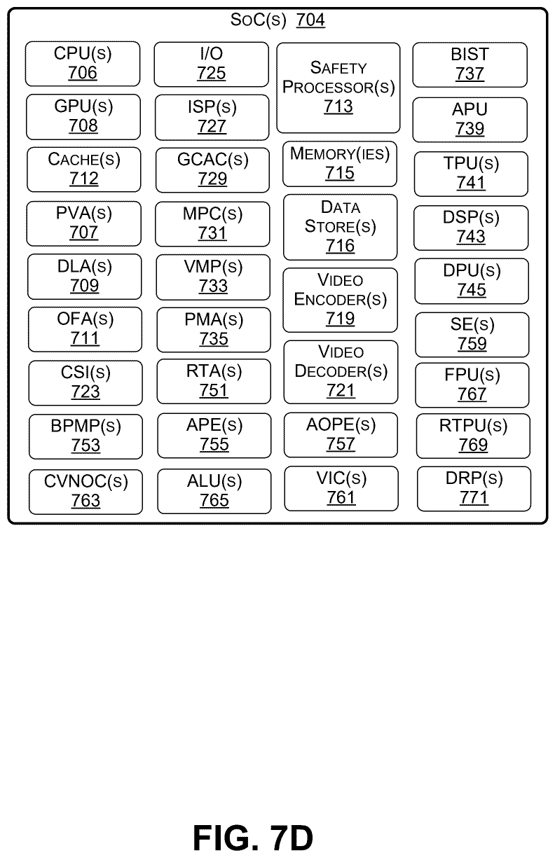

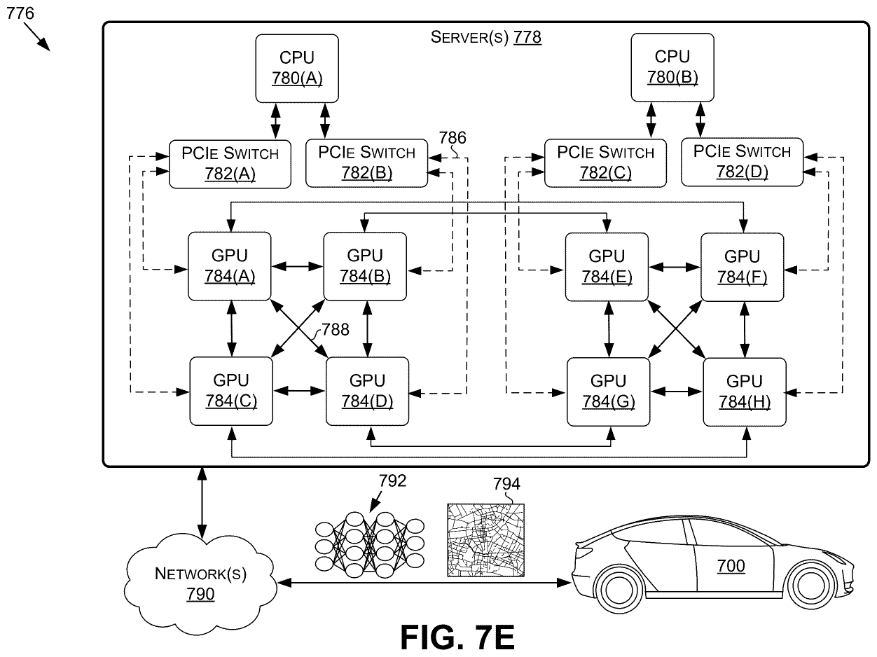

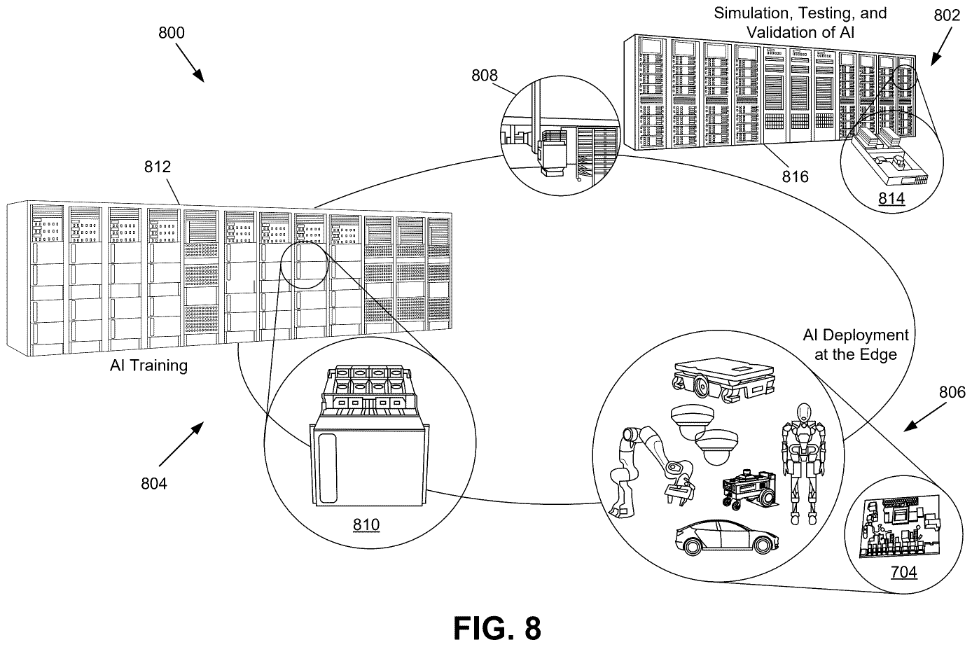

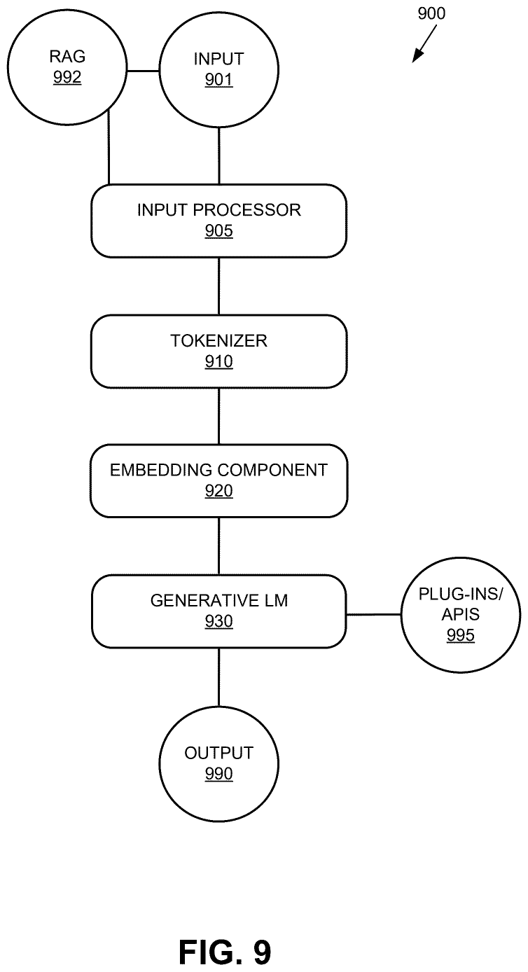

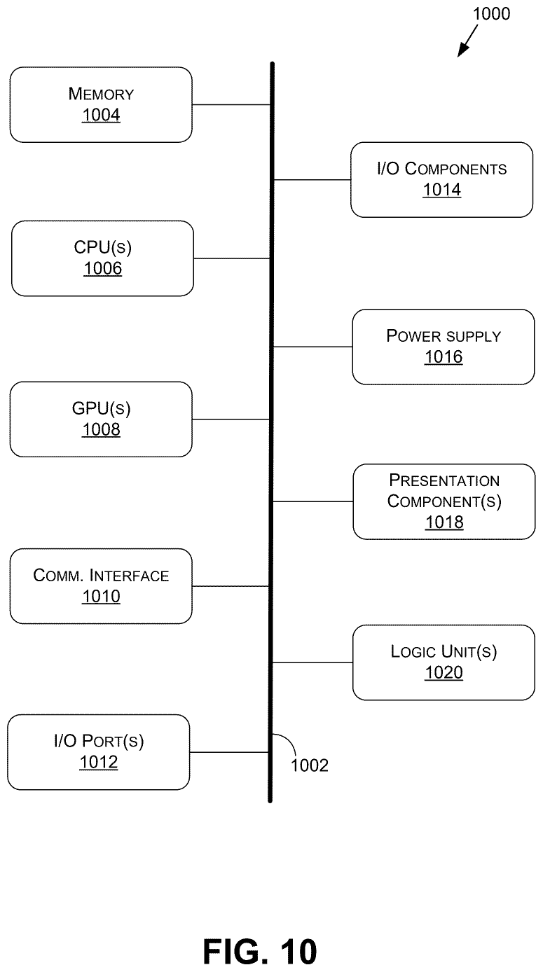

Systems and methods are disclosed related to implementing dexterous grasping with geometric fabrics. Although the present disclosure may be described with respect to an example autonomous or semi-autonomous vehicle, robot, and/or other machine type 700 (alternatively referred to herein as “vehicle 700,” “ego-vehicle 700,” “machine 700,” “ego-machine 700,” “robot 700,” and/or “ego-robot 700,” an example of which is described with respect to FIGS. 7A-7E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to controlling robots for object grasping/manipulation tasks, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where autonomous grasping robots may be used. In some embodiments, the systems, methods, and/or processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

This disclosure relates to systems and methods for implementing dexterous grasping with geometric fabrics. Achieving fast, safe, and robust dexterous grasping across a diverse range of objects is useful for a variety of robotics applications, including industrial applications. Dexterous grasping technology can be used to automate various tasks, such as handling different objects in manufacturing, logistics, or other industrial settings. The ability to manipulate objects with precision and reliability is useful for automating processes that involve complex interactions with diverse items, including fragile or irregularly shaped objects.

Existing attempts to implement dexterous grasping often suffer from limited speed, dexterity, generality, or a combination thereof. Conventional approaches also fail to properly implement hardware safety guarantees, collision avoidance, or handling of high-dimensional observation and action spaces. These limitations hinder the effective deployment of dexterous grasping techniques in real-world industrial applications. For example, conventional systems fail to adapt to new or unexpected objects, leading to failures in grasping or manipulation tasks. Additionally, the lack of robust safety mechanisms can result in collisions or damage to both the robotic system and the objects being handled.

The techniques described herein improve upon these shortcomings by providing a geometric fabric controller that implements dynamic and reactive dexterous grasping in real-world environments. The techniques described herein combine reinforcement learning, geometric fabrics, and teacher-student distillation to train/update a machine-learning model to generate control instructions for accurate grasping of real-world objects. Reinforcement learning enables the machine-learning model to learn grasping strategies through trial and error, using geometric fabrics to introduce constraints that guide the learning process. The geometric fabric controller can be used to create an inductive bias for model learning, avoid collisions, uphold joint constraints, and facilitate safe real-world deployment even with potentially hazardous models.

To implement these techniques, a privileged teacher model can be trained/updated in a simulation and distilled into a depth-based student model. This enables zero-shot sim-to-real transfer, achieving improved dexterous grasping performance on diverse objects in physical environments. In some implementations, the approaches described herein can use depth images and other sensory inputs to generalize across different object geometries, allowing the robot to continuously grasp and transport a variety of objects at high speed. The student model can be trained/updated to generate actions that are provided as input to the geometric fabric, which translates the actions into control instructions for the robotic arm.

The use of depth images can provide information about the shape and position of objects can cause the machine-learning model to be trained/updated learn to adapt to different types of objects, orientations, and environments. In some implementations, the additional input such as random wrench perturbations, pose noise, friction reduction, or domain randomization can be incorporated to improve robustness, such that the machine-learning model can handle exogenous perturbations and uncertainties in object position and geometry.

In some implementations, the techniques described herein can use stereo red-green-blue (RGB) images or other types of color images as an alternative to, or in addition to, depth-based images. Color images may be less affected by environmental factors and can be used with pre-trained visual models to improve training/updating performance of the machine-learning models described herein. In such implementations, a similar geometric fabric controller can be implemented. The controller can execute the grasping actions based on grasping actions generated using the models trained/updated according to the techniques described herein.

In implementations implementing stereo color images, the student model can include one or more transformer layers, which process output of a convolutional backbone networks to generate depth information from stereo images. The transformer layers can implement cross-attention across both input images, thereby capturing visual and depth information from the stereo image pairs. When distilling the student model based on simulation data, real-time renderings of the simulation environment can be generated and provided as input to the student model, with other signals such as object position data or proprioception data being used in part to calculate an auxiliary loss. The auxiliary loss can be combined with an action loss comparing the actions generated by the teacher model and the student model to train/update the student model.

The trained/updated student model can be used in connection with real-world environments, in which stereo cameras capture images of target objects and their surrounding environment to perform grasping tasks. A state machine can be used to process the output of the student model, managing the activation and deactivation of the geometric fabric controller based on the predicted object positions. The techniques described herein can be applied to a variety of different industrial applications, such as bin packing, object transportation or storage, or general grasping and object manipulation.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine simulation states for training/updating teacher models and/or student models, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., robotic motion, object physics, or environmental physics, among others, from within the simulation. The synthetic training data (in addition to or alternatively from real-world data) may then be used or processed to train/update the various machine-learning models described herein.

In any example, such as where a simulation environment is used for testing, validation, training, etc., the simulation environment and/or associated training data may be rendered or otherwise generated using one or more light transport simulation algorithms-such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, the systems and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAS, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

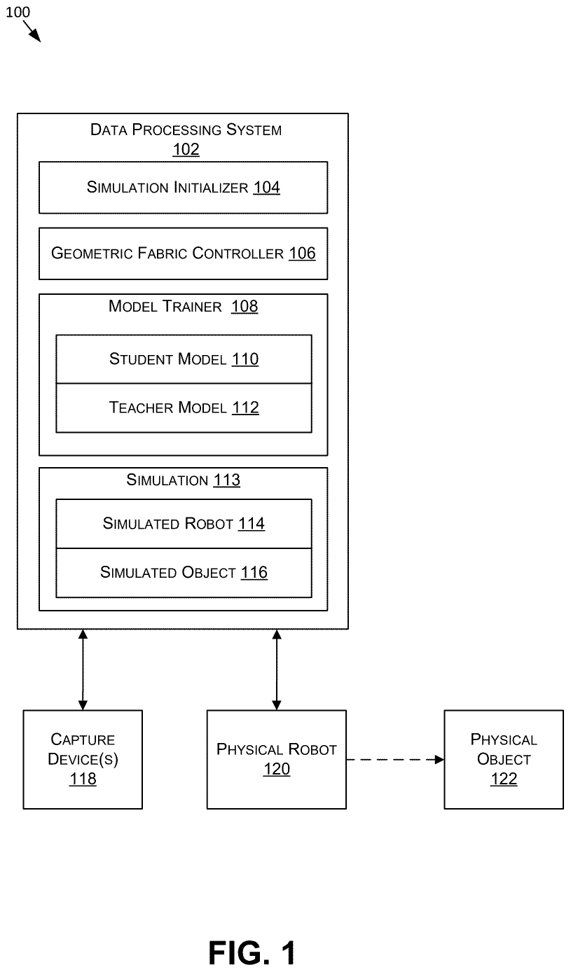

With reference to FIG. 1, FIG. 1 is an example computing environment including a system 100 for implementing dexterous grasping with geometric fabrics, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

The system 100 can be used to implement dexterous grasping with geometric fabrics according to the techniques described herein. The system 100 is shown as including a data processing system 102, one or more capture devices 118, a physical robot 120, and a physical object 122. The data processing system 102 is shown as including a simulation initializer 104, geometric fabric controller 106, a model trainer 108, and a simulation 113. The model trainer 108 is shown as including a student model 110 and a teacher model 112. The simulation 113 is shown as including a simulated robot 114 and a simulated object 116.

The data processing system 102 can include one or more processors, circuits, memory, and/or computing devices/systems that can perform the various techniques described herein. The data processing system 102 can be used to train/update one or more student models 110 according to the techniques described herein to generate control instructions for the physical robot 120 to manipulate one or more physical objects 122 in a physical environment. The data processing system 102 can initiate one or more training/update processes according to the techniques described herein in response to one or more requests, such as requests and/or input from operator(s) of the data processing system 102, from requests from other processes executing at the data processing system 102, and/or requests from external computing systems in communication with the data processing system 102.

Initiating the training/updating processes described herein can involve executing the simulation initializer 104 and the model trainer 108 to implement a multi-stage fabric-guided policy (FGP) training/update process, as described in further detail herein. The multi-stage FGP training/update process can include training/updating one or more teacher models 112 based on state information of one or more simulations 113, which include a simulated robot 114 and at least one simulated object 116. The teacher model 112 can be trained/updated to generate control instructions for the simulated robot 114 to manipulate one or more simulated objects 116 in the simulation 113 via a geometric fabric controller 106. Once the teacher model 112 has been trained/updated, a subsequent training/update stage can be executed in which the teacher model 112 is distilled to a student model 110, which can be trained/updated to generate control instructions for the simulated robot 114 using input depth images and/or RGB images derived from the simulation 113, as described in further detail herein. The trained/updated student model 110 can then be executed within a real-world environment, in which the student model 110 is used to generate control actions for the physical robot 120 to manipulate the physical object 122 according to images captured using the capture device(s) 118, as described in further detail herein.

To train/update the various machine-learning models described herein, the data processing system 102 can execute the simulation initializer 104. The simulation initializer 104 can initialize a simulation 113 including a simulated robot 114 and a simulated object 116. The simulation initializer 104 can include hardware, software, or combinations thereof, to configure and execute the simulation 113. The data processing system 102 can execute the simulation initializer 104 in response to one or more requests, such as requests from an operator of the data processing system 102, messages from external computing systems providing simulation parameters, or predefined schedules, among others. The simulation initializer 104 can create the simulation 113 by specifying and/or accessing configuration parameters such as environmental geometry, robot kinematic parameters, meshes and/or other parameters for the simulated robot 114 and the simulated object 116, environmental meshes and/or constraints, and/or a goal position for the simulated object 116, among others. In some implementations, parameters for the simulation 113 can be received in formats such as binary files, text-based configurations, or received via application programming interface (API) messages, among others. In some implementations, the simulation initializer 104 can allocate one or more regions of memory of the data processing system 102 to establish the simulation 113. The simulation 113 can be executed to be synchronized with one or more operations of the model trainer 108, as described herein, to facilitate training/update processes of the various machine learning models described herein.

In some implementations, the simulation initializer 104 can initialize the simulation 113 by accessing simulation parameters defining meshes, geometries, and position data of one or more simulated objects 116, parameters for the simulated robot 114 (e.g., mesh data, joint information, joint constraints, etc.), environmental physics properties (e.g., environmental meshes, collision data, etc.), and a goal position for the simulated object 116, among others. Using the parameters, the simulation initializer 104 can instantiate the simulated robot 114 and simulated object 116 within the simulation 113. The simulation initializer 104 can set environmental constraints such as friction coefficients, gravity values, or collision detection tolerances, among others. In some implementations, the simulation initializer 104 can validate any simulation parameters (e.g., provided in configuration settings or in a request to train/update one or more machine learning models) against predefined validity criteria to validate that the configuration settings are compatible with the simulation 113 and model trainer 108. In some implementations, the data processing system 102 can execute the simulation 113 such that the simulation 113 is synchronized with one or more operations of the model trainer 108. In some implementations, during execution, the data processing system 102 can provide various data, such as simulation state data, including object positions, robot configurations, proprioception data, and/or sensor readings, among others, to the model trainer 108 to facilitate any of the training/update operations described herein.

The simulation 113 can include a simulated environment in which the simulated robot 114 can be instructed to manipulate one or more simulated objects 116. In some implementations, the simulation 113 can include a three-dimensional (3D) simulated environment in which the simulated robot 114 and simulated object 116 can be represented as meshes. Examples of simulated environments can include industrial settings such as warehouses, assembly lines, work tables, or factory settings, among others. The simulated objects 116 can be represented using a variety of different geometries, including but not limited to meshes for fragile items, irregularly shaped components, or high-precision parts, among others. In some implementations, the simulation initializer 104 can initialize multiple simulations 113 with varying parameters, such as object geometries, environmental physics properties, or robot kinematic constraints, to enable the teacher model 112 and student model 110 to be trained/updated across diverse scenarios, thereby improving robustness to real-world conditions.

The simulation 113 can be executed by the data processing system 102 at one or more predetermined simulation rates (e.g., 60 Hertz (Hz), 30 Hz, 120 Hz, etc.). To do so, the data processing system 102 can update a state of the simulation 113 in discrete time steps according to the simulation rate. At each time step, the data processing system 102 can compute updated state variables for the simulated robot 114 and simulated object 116, including robot movements and object/robot positions, velocities, and/or applied forces, among others. The data processing system 102 can implement physics-based computations to model interactions between the simulated robot 114, the simulated object(s) 116, and environment, such as collisions, gravitational effects, or actuator torques, among others. In some implementations, and as described in further detail herein, the simulation 113 can be synchronized with operations of the model trainer 108 by providing real-time access to simulation state data, simulated sensor data, and/or other information derived from the state information according to an update rate of the machine learning models described herein (e.g., the teacher model 112, the student model 110, etc.).

In some implementations, the data processing system 102 can update the state of the simulation 113 at each time step according to input actions provided via the geometric fabric controller 106 and/or external sources of force. For example, the data processing system 102 may use any generated control instructions for the simulated robot 114 to generate resulting joint displacements/movements, end-effector trajectories, or object displacements based on according to the output of the geometric fabric controller 106, as described in further detail herein. The data processing system 102 can update simulated sensor data derived from the simulation 113, such as depth images, RGB images, or proprioception signals, to reflect an update state of the environment in the simulation 113. In some implementations, the data processing system 102 can randomize parameters such as friction coefficients, lighting conditions, or object mass distributions during simulation initialization and/or runtime to improve the robustness of the trained/updated machine learning models to changes in environmental conditions.

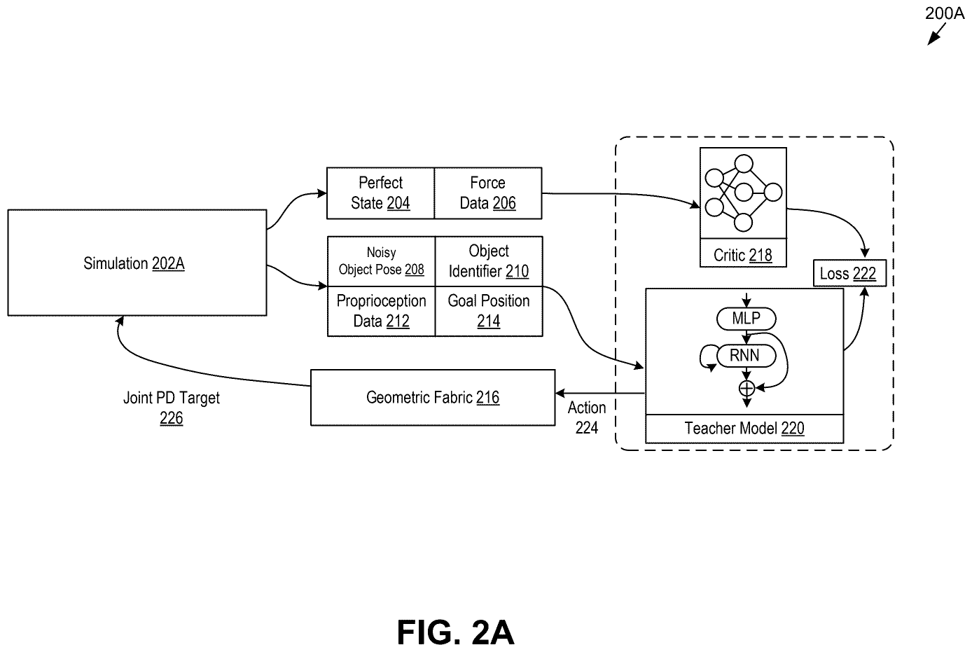

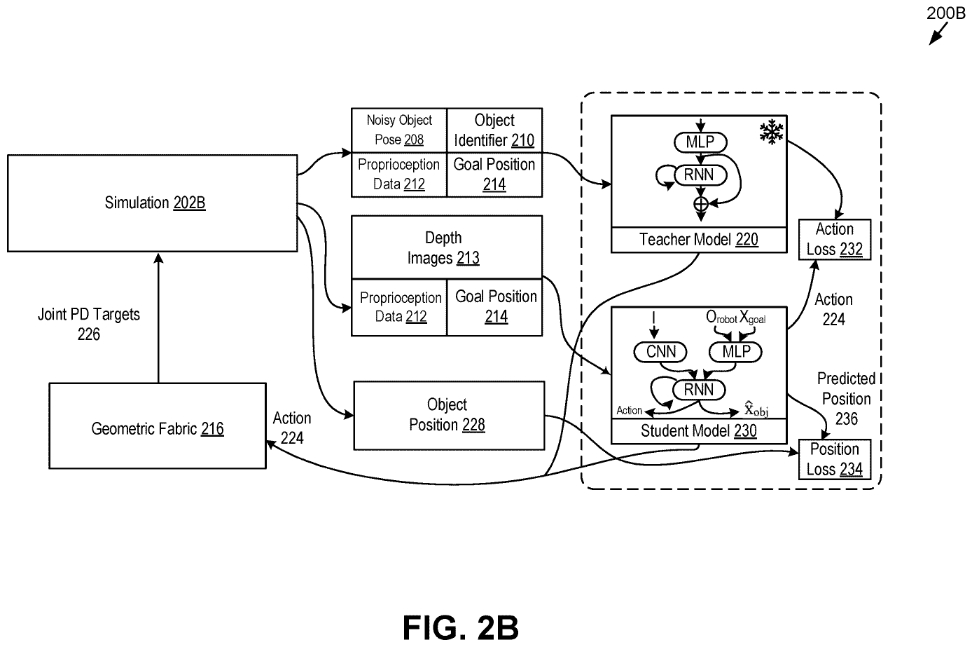

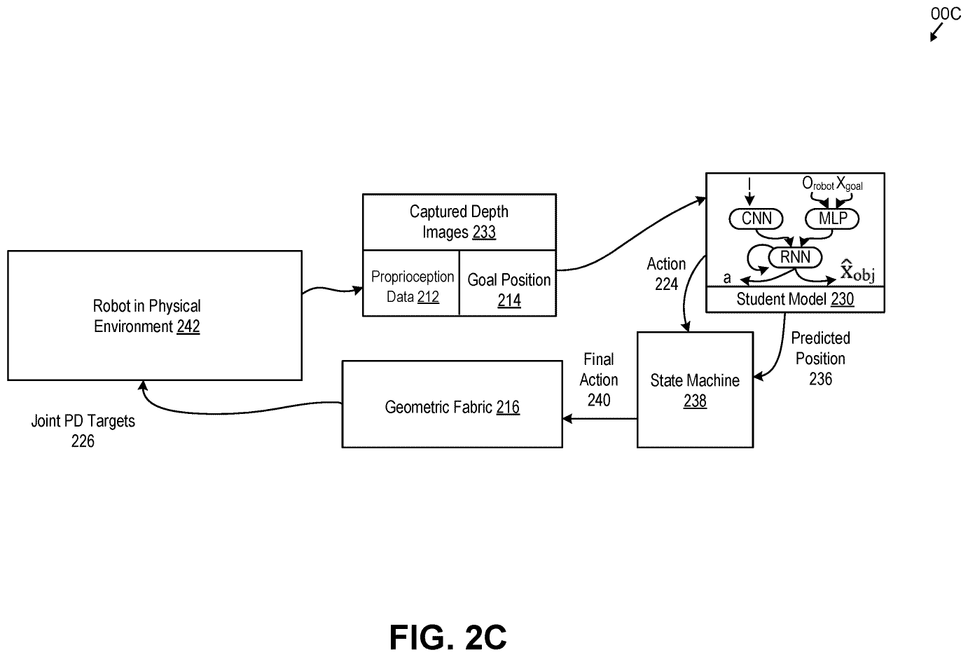

The model trainer 108 can update the teacher model 112 to generate first actions for a geometric fabric associated with the simulated robot 114 using state information of the simulation 113 and position information of the simulated object 116. The model trainer 108 can include hardware, software, or combinations thereof to execute training/update processes for the teacher model 112 and student model 110. The data processing system 102 can execute the model trainer 108 in response to one or more requests, such as instructions from an operator of the data processing system 102, messages from external computing systems specifying training parameters, or predefined schedules, among others. During a first training/update stage, the model trainer 108 can configure the teacher model 112 to process simulation state data, including object positions, robot configurations, and environmental constraints, to generate control actions that comply with geometric fabric constraints. These actions can be validated against success criteria, such as achieving the goal position of the simulated object 116, to compute gradients for updating the teacher model 112. Details of this first training/update stage are described in connection with FIG. 2A.

Referring to FIG. 2A in the context of the components described in connection with FIG. 1, depicted is block diagram 200A showing an example data flow for training/updating a teacher model 220 (e.g., the teacher model 112) for implementing dexterous grasping with geometric fabrics 216, in accordance with some embodiments of the present disclosure. The diagram 200A shows at least one simulation 202A, which provides perfect state data 204 (sometimes referred to herein as “state data 204”) and force data 206 as input to a critic model 218. The simulation 202A is also shown as providing noisy object pose data 208, object identifier data 210, proprioception data 212, and goal position data 214 as input to the teacher model 220. The teacher model 220 can be trained/updated, for example, by the model trainer 108 using the loss 222, as described in further detail herein, to generate actions 224 to control the robot (e.g., the simulated robot 114) in the simulation 202A. As shown, the actions 224 are provided as input to the geometric fabric 216 (e.g., the geometric fabric controller 106), which generates joint proportional-derivative (PD) targets 226 for the robot in the simulation 202A.

The simulation 202A can be similar to, and can include any of the structure and functionality of, the simulation 113 of FIG. 1. The simulation 202A can be initialized by the simulation initializer 104 using parameters specific to a first training/update stage for the teacher model 112. The simulation 202A can include a simulated robot and a simulated object positioned within a three-dimensional simulated environment, along with environmental physics properties such as friction coefficients, collision tolerances, or gravity values, among others, as described herein. The simulation 202A to execute physics-based computations at a predetermined simulation rate (e.g., 60 Hz, 15 Hz, etc.) to update the state data 204 variables of the simulated robot and simulated object at discrete time steps. During execution, the simulation 202A can provide real-time access to simulation state data, including object positions, robot configurations, and proprioception signals, to the model trainer 108. In some implementations, the simulation initializer 104 can randomize parameters such as object geometries, lighting conditions, or joint constraints of the simulated robot to improve robustness of the teacher model 112. The simulation 202A can be synchronized with operations of the model trainer 108 by transmitting updated simulation state data at intervals corresponding to the training/update rate of the teacher model 112.

The state data 204 of the simulation 202A can be updated and generated during execution of the simulation. The state data 204 can include parameters such as the simulated robot joint position q∈ [symbol] ^{N}^{_{q}}, which in some implementations can be represent a vector of all joint angles or positions across its degrees of freedom (DoF). In one example, the robot can have multiple fingers, and can include 23 degrees of freedom (e.g., N_{q}=23). In some implementations, the state data 204 can include the simulated robot joint velocity \dot{q}∈ [symbol] ^{N}^{_{q}}, which can represent a time derivative of the configuration vector and can encode velocities of all joints of the simulated robot. The state data 204 can include palm positions defined, in one example, by at least three 3D points on the palm of the simulated robot, [xₚₐₗₘ, xₚₐₗₘ₋ₓ, x_{palm-y}], specifying the center and orthogonal directions of the simulated robot's palm. In some implementations, the state data 204 can include the fingertip positions of the simulated robot. In some implementations, the simulated robot can include four fingertips, where the positions are represented as x_{fingertips}∈ [symbol] ^{N}^{_{fingers}}^{×3}, In some implementations, the state data 204 can include state parameters of the geometric fabric 216, represented as [q_{ƒ}, \dot{q}_{ƒ}, \ddot{q}_{ƒ}]. The state data 204 can be privileged, and provided only to the critic model 218, to prevent the teacher model 112 from learning dependencies on information inaccessible to real-world sensors, such as exact joint configurations or deformable object states.

The state data 204 can further include object position information such as the true object position x_{obj}∈ [symbol] ³, specifying the exact 3D coordinates of a simulated object in the simulated environment of the simulation 202A. In some implementations, the state data 204 can include the object quaternion x_{obj}∈ [symbol] ⁴, a unit quaternion encoding of the orientation of the object relative to the simulated environment of the simulation 202A. In some implementations, the state data 204 can include the velocity of the object, represented as ν_{obj}∈ [symbol] ³, which can represent the translational speed and direction of the corresponding simulated object in the simulation 202A. In some implementations, the state data 204 can include the true object angular velocity ω_{obj}∈ [symbol] ³, which in some implementations can be stored as a 3D vector indicating rotational speed and axis of rotation. In some implementations, the state data 204 can include one or more object identifiers of one or more of the simulated objects. In some implementations, the state data 204 can include data identifying the goal position (e.g., x_{goal}∈ [symbol] ³, etc.) of the simulated object(s) in the simulation (e.g., the goal position data 214, etc.). In some implementations, the state data 204 can include other information about the environment, including positions and/or orientation data for different obstacles, environmental features, or environmental objects (e.g., other than those to be manipulated by the simulated robot, etc.).

The force data 206 can include information relating to the forces within the simulation 202A. The force data 206 can encompass components such as robot joint forces ƒ_{dof}∈ [symbol] ^{N}^{_{q}}, which can represent the torques or forces applied to each of the joints of the simulated robot (e.g., degrees of freedom). In some implementations, the force data 206 can include the vector ƒ_{fingers}∈ [symbol] ^{N}^{_{fingers}}^{×3}, which can store the 3D contact forces (e.g., along the x, y, and z axes) acting on each of the fingertips of the simulated robot. These forces can be used, for example, to quantify tactile engagements, such as grasping pressures or collisions experienced by the robot. In some implementations, the force data 206 can include environmental forces such as gravitational forces acting on the simulated object, specifying the direction and magnitude of downward acceleration due to gravity. In some implementations, the force data 206 can store collision forces between simulated object(s), the simulated robot, and/or the simulated environment within the simulation. Similar to the perfect state data 204, the force data 206 can remain privileged to isolate the teacher model 112 from dependencies on impractical real-world sensor measurements of internal simulation states or fine-scale environmental forces.

In addition to the state data 204 and the force data 206, the simulation 202A can provide noise object pose data 208, object identifier data 210, proprioception data 212, and goal position data 214. The object identifier data 210 can include an identifier of the object that is to be manipulated by the simulated robot in the simulation 202A. In some implementations, the object identifier data 210 can include a one-hot identifier of a classification of the simulated object. In some implementations, the object identifier data 210 can include a different type of object classification. The proprioception data 212 can include position data of the robot, including but not necessarily limited to one or more of the simulated robot joint position q∈ [symbol] ^{N}^{_{q}}, the simulated robot joint velocity \dot{q}∈ [symbol] ^{N}^{_{q}}, at least three 3D points on the palm of the simulated robot, [xₚₐₗₘ, xₚₐₗₘ₋ₓ, x_{palm-y}], the fingertip positions of the simulated robot x_{fingertips}∈ [symbol] ^{N}^{_{fingers}}^{×3}, and/or state parameters of the geometric fabric 216 (e.g., [q_{ƒ}, \dot{q}_{ƒ}, \ddot{q}_{ƒ}], etc.). The goal position data 214 can be a 3D coordinate of the goal position of the simulated object within the simulation 202A (e.g., x_{goal}∈ [symbol] ³).

The noisy object pose data 208 can be generated based on the object position x_{obj} of the simulated object in the simulation 202A and/or the object orientation (quaternion) q_{obj} of the simulated object in the simulation 202A. The noisy object pose data can include noisy object position information, which can be represented as \tilde{x}_{obj}=x_{obj}+n_{x,uncorr}+n_{x,corr}, and noisy object orientation (quaternion) information, which can be represented as \tilde{q}_{obj}=q_{obj}+n_{q,uncorr}+n_{q,corr}. The noise value n_{x,uncorr} can correspond to uncorrelated noise for object position that is sampled each timestep of the simulation 202A via n_{x,uncorr}˜ [symbol] (0, σ_{xyz,uncorr}), and the noise value n_{x,corr} can correspond to correlated noise for object position that is sampled once at the start of the simulation 202A via n_{x,corr}˜ [symbol] (0, σ_{xyz,corr}), and kept constant through each timestep of the simulation 202A. The noise value n_{q,uncorr} can correspond to uncorrelated noise for object orientation that is sampled each timestep of the simulation 202A via n_{q,uncorr}˜ [symbol] (0, σ_{rpy,uncorr}), and the noise value n_{q,corr} can correspond to correlated noise for object position that is sampled once at the start of the simulation 202A via n_{q,corr}˜ [symbol] (0, σ_{rpy,corr}), and kept constant through each timestep of the simulation 202A. The model trainer 108 can use any suitable random number generation and/or sampling process to generate the noise values for the object position and orientation.

The simulation 202A can be initialized, for example, by randomly sampling an object pose and robot configuration. In some implementations, a simulation may include an environment in which the simulated robot and the simulated object are provided on a 3D table. In some implementations, multiple simulations 202A may execute simultaneously (e.g., using parallel processing techniques). Each simulation 202A may be implemented using a different robot, object, and/or environmental configuration, with the output of each simulation 202A or data derived therefrom (e.g., perfect state data 204, force data 206, noisy object pose 208, object identifiers 210, proprioception data 212, goal position 214, etc.). In one example, 8192 simulations 202A run in parallel to train/update the critic model 218 and the teacher model 220 according to the techniques described herein. In some implementations, the simulation 202A can be initialized according to random or pseudo-random values.

The perfect state data 204 and the force data 206 can be provided as input to the critic model 218. In some implementations, the critic model 218 can be a multi-layer perceptron (MLP) network that can process concatenated inputs from the state data 204 and force data 206. The critic model 218 can include an input layer that merges one or more data structures including information of the state data 204 and information of the force data 206 into an input vector, followed by one or more hidden layers. In some implementations, the critic 218 can receive the noisy object pose 208, the object identifier 210, the proprioception data 212, and the goal position 214 as input.

In one example, the critic model 218 can include a neural network having an MLP architecture with layer dimensions [512, 512, 256, 128]. The critic model 218 can be trained/updated to predict the cumulative reward from the state s of the simulation (given the corresponding input data from the simulation 202A). The estimated state value can be used to calculate the loss 222. The loss 222 can be, in some implementations, a proximal policy optimization (PPO) loss value, which can be a comparison of the predicted state-values with temporally discounted returns calculated from simulated trajectories within the simulation 202A. The critic model 218 and the teacher model 220 can be trained/updated using a PPO process, as described in further detail herein.

The teacher model 220 can be similar to, and include any of the structure or implement any of the functionality of the teacher model 112 of FIG. 1, and vice versa. The teacher model 220 can include one or more MLP layers and/or one or more recurrent neural network layers. In one example, the teacher model 220 can include an MLP layer followed by a long-short term memory (LSTM) layer, which can capture temporal dependencies between observations. In some implementations, and as shown here, the teacher model 220 can include a skip connection around the recurrent neural network layers to facilitate passthrough of the policy information around the recurrent neural network layers, effectively treating the outputs of the recurrent neural network layers as residuals. In one example implementation, the MLP layer(s) of the teacher model 220 can have a size of [512, 512] and the LSTM layer(s) of the teacher model 220 can have a size of 1024. Various other configurations are also possible.

The teacher model 220 and the critic model 218 can be trained/updated using a PPO reinforcement learning process. Training/updating the teacher model 220 using PPO can be performed to learn a policy that maximizes the expected cumulative reward obtained from actions 224 generated for controlling the simulated robot within the simulation 202A. The critic model 218 and the teacher model 220 can be updated in an asymmetric actor-critic training/updating technique. As shown, one or more outputs of the teacher model 220 and the critic model 218 can be used to calculate a loss 222, which is used to update the teacher model 220. In some implementations, the critic model 218 can be updated using a different loss, which can quantify the difference between the predicted value of the states of the simulation 202A and target estimate values of states of the simulation 202A. The loss 222 can be a PPO loss, and can be a function of the output of the critic model 218 and the predicted actions 224 generated by the teacher model 220.

More specifically, the teacher model 220 can be trained/updated to generate output actions 224 to control the simulated robot in the simulation 202A via the geometric fabric. The simulated actions 224, when controlled via the robot, can affect the state of the simulation 202A. When the state of the simulation 202A changes, the model trainer 108 can evaluate a reward function for the corresponding state, action, and resulting next state of the simulation. In one example, the reward function can be a weighted sum of multiple reward functions, which can be represented as r=Σᵢ wᵢrᵢ, where r is the total reward, rᵢ is the i-th reward value, and wᵢ is the weight for the i-th reward value. In some implementations, following reward terms of the weighted sum can be used to train/update the critic model 218 and the teacher model 220:

$${r}_{to - o b j} = minimize ( ‖ {x}_{fingertips} - {x}_{obj} ‖ )$$

$${r}_{lift} = minimize ( {z}_{lifted} - z ( {x}_{obj} ) ) \times ( 1 - lifted ( {x}_{obj} ) )$$

$${r}_{lifted} = lifted ( {x}_{obj} )$$

$${r}_{to - goal} = minimize ( ‖ {x}_{goal} - {x}_{obj} ‖ ) \times lifted ( {x}_{obj} )$$

$${r}_{reached} = 𝕝 ( ‖ {x}_{goal} - {x}_{obj} ‖ < {d}_{success} )$$

$${r}_{success} = 𝕝 ( {r}_{reached} = 1 for {T}_{success} consecutive timesteps ) \times ( {T}_{ma x} - T )$$

In the above equations, the reward value r_{to-obj} corresponds to the minimum distance calculated as the Euclidean norm between the positions of the fingertips of the simulated robot and the simulated object (e.g., the simulated object 116). The reward value r_{lift} corresponds to the difference between a predefined lifted height z_{lifted} and a current vertical position z(x_{obj}) of the simulated object, multiplied by a term that indicates whether the object position remains below the lifted height threshold. The function “lifted” is equal to one if the vertical component of the input argument is greater than a predetermined height threshold z_{lifted}. The reward value r_{lifted} corresponds to an indicator reward triggered at the first occurrence when the vertical position of the object exceeds the predetermined height threshold z_{lifted}. The reward value r_{to-goal} corresponds to the distance calculated as the Euclidean norm between the goal position and the current simulated object position, multiplied by an indicator term that activates when the simulated object position is at or above the lifted height.

The function [symbol] (c) is equal to one if the value c is true, and is equal to zero otherwise. The reward value r_{reached} corresponds to an indicator reward activated at each timestep when the Euclidean distance between the goal position and the object position is within a distance threshold d_{success}. The reward value r_{success} corresponds to an indicator value activated after the reward r_{reached} has been continuously active for a predetermined number of consecutive timesteps of the simulation 202A referred to as T_{success}, scaled by the remaining episode time (Tₘₐₓ−T). In the previous expression, Tₘₐₓ is the maximum number of timesteps of the simulation 202A and T is the number elapsed timesteps of the simulation. The predetermined height value z_{lifted} can correspond to a predetermined vertical height above a simulated table height z_{table}, in implementations where the simulated environment of the simulation 202A includes an object on a table.

In the above reward equations, the “minimize” function can be used as a stateful reward function, where minimize (e)=max(eₛₘₐₗₗₑₛₜ-e, 0). In this equation, e can be defined as the error term to be minimized, and eₛₘₐₗₗₑₛₜ can be defined as the smallest the error term has been in the episode of the simulation 202A so far. The minimize function can provide a positive reward value if the error term drops below the lowest it has been so far, otherwise returning zero In response to determining a positive reward (e.g., indicating that the error term has dropped below eₛₘₐₗₗₑₛₜ), the smallest observed error term eₛₘₐₗₗₑₛₜ can be updated to reflect the improved error magnitude. In some implementations, the environment of the simulation 202A can be reset when an object has fallen below the table (e.g., in implementations where the simulated environment includes a table), if the simulated robot received the success reward r_{success}, or if the simulation episode time limit has been reached. The reset conditions may be expressed as part of the following equation:

$$reset = any ( z ( {x}_{obj} ) < {z}_{table} , {r}_{success} = 1 , T > {T}_{ma x} )$$

During the first stage of the training/update process, the. critic model 218 can process the state data 204, the force data 206, and any other input data described herein, to generate predictions of a value of state-action pairs representing outcomes of actions 224 that are generated by the teacher model 220. The state-action pairs can represent an estimate of the expected cumulative reward that results from the actions 224. The actions 224 generated by the teacher model 220 can serve as inputs to the geometric fabric 216. As described in further detail herein, the geometric fabric 216 can translate the actions 224 into joint proportional-derivative (PD) targets 226 for the simulated robot to update the state of the simulation 202A. The critic model 218 can be trained/updated by comparing the predictions generated by the critic model 218 against actual returns calculated from observed consequences associated with the state-action pairs, resulting in a critic loss. The critic loss can be used to modify parameters of the critic model 218 during the training/update process, for example, using a suitable backpropagation and corresponding optimization function (e.g., gradient descent, Adam optimizer, etc.).

As described herein the asymmetric actor-critic training/update process can implement a PPO process to train/update the teacher model 220. In doing so, resulting updated state of the simulation 202A, which is affected based on the actions 224 generated by the teacher model 220, can be used to generate reward data according to the reward terms described herein. The model trainer 108 can compute the loss 222 as a function of the output from the critic model 218, such that the loss 222 incorporates differences between the predicted cumulative reward and actual returns accumulated through the updated state of the simulation 202A. The loss 222 can represent how effectively generated actions 224 correspond to target outcomes. The model trainer 108 can use the loss 222 to train/update the parameters of the teacher model 220 using a suitable optimization function.

The actions 224 generated by the teacher model 220 can include target position values provided as inputs to the geometric fabric 216 for controlling the simulated robot within the simulation 202A. In some implementations, the teacher model 220 can generate the actions 224 as an action vector of combined robot control instructions, represented as [x_{ƒ,target}, r_{ƒ,target}, x_{pca,target}]. In this example, x_{ƒ,target} corresponds to a target palm position for the simulated robot, r_{ƒ,target} corresponds to a target palm orientation (e.g., in Euler angles), and x_{pca,target} corresponds to a principal component analysis (PCA)-derived component vectors to control the fingers of the simulated robot. For example, x_{pca,target} can include a data structure of position targets in a taskmap projection that corresponds to desired finger joint configurations of the simulated robot within the simulation 202A.

The geometric fabric 216 can be similar to, and implement any of the structure and/or functionality of, the geometric fabric controller 106 of FIG. 1, and vice versa. The geometric fabric 216 can be used to translate control actions 224 into joint proportional-derivative targets 226, which can direct the simulated robot within the simulation 202A to perform dexterous grasping tasks. In some implementations, the geometric fabric 216 can be derived by integrating various task constraints, forces, and metrics modeled as second-order differential equations having velocity-dependent behaviors and prioritized structures. Such differential equations can define relationships between geometric accelerations, metric-based prioritizations (e.g., mass terms), velocity-dependent damping components, and externally provided forcing actions (e.g., the actions 224 from the teacher model 220, etc.), among others. The geometric fabric 216 can represent structured constraints related to hardware-specific physical limits for the simulated robot, including but not limited to joint positional limits, joint accelerations and jerk constraints. The geometric fabric 216 can encode collision avoidance behaviors based on geometric representations of the simulated robot and the simulated object, among other geometric representations, in some implementations. In one example, the acceleration of the simulated robot according to the geometric fabric can be represented via the following equation:

$${\ddot{q}}_{f} = - {M}_{f}^{- 1} ( {f}_{f} + {f}_{π} ( a ) )$$

In the above equation, \ddot{q}_{ƒ} can represent the acceleration of the simulated robot of the simulation 202A in the configuration space of the geometric fabric 216, and can be a second time-derivative of the generalized coordinates (e.g., joint angles and positions) of the simulated robot generated via the geometric fabric 216. The metric

$${M}_{f}^{- 1}$$

can represent the inverse of the geometry-shaped priority/importance across different motion directions, and is inverted to represent how effectively the simulated robot responds to applied geometric and learned forces. The term ƒ_{ƒ} can represent a “nominal force” term for the geometric fabric 216, which can include collision-avoidance, joint-limit, posture-control, and obstacle avoidance reaction forces. For example, the term ƒ_{ƒ} can represent a set of passive control behaviors that enforce hardware-safe motion. The function ƒ_{π}(a) can represent one or more task-related forces derived from actions 224 (e.g., the value a) generated via the teacher model 220. The function ƒ_{π} can translate the input actions 224 into a force input for motion towards task goals such as grasping and transportation.

The geometric fabric 216 can be derived/generated prior to performing the various asymmetric actor critic training/updating techniques described herein. The geometric fabric 216 can be derived to implement both environmental and self-collision avoidance. In deriving/defining the geometric fabric 216, the geometry of the robot (e.g., the simulated robot 114, the physical robot 120, etc.) can be approximated using a collection of spheres. The geometric fabric 216 can be defined as having an explicit collision avoidance response through construction of a base metric response at each relevant sphere position. The forward kinematics transformation can be applied from robot configuration to an origin location of individual attachment spheres on the robot body, which can be represented mathematically by the mapping x=φ_{fk}(q), where the vector q can represent the current joint configuration, the vector x can represent the origin locations of individual spheres on the corresponding joints, and φ_{fk} represents the forward kinematics function. A base metric response for the geometric fabric 216 can be formulated at each sphere point as:

$${M}_{b} = {\sum }_{i} \underline{\frac{{s}_{i}}{{d}_{i}}} {\hat{n}}_{i} ⊗ {\hat{n}}_{i}$$

In the above equation, M_{b} can represent the base metric,

$${s}_{i} = \frac{1}{2} tanh ( - {α}_{1} ( {v}_{i} - {α}_{2} ) + 1 )$$

and represents the smooth velocity gate that increases when the corresponding sphere point is moving towards collision body i, νᵢ=−\dot{x}·\hat{n}ᵢ and can represent the signed impact speed that is positive when moving away from collision and negative towards collision, and

$${\hat{n}}_{i} = \frac{{r}_{i} - x}{( {r}_{i} - x )}$$

and can represent a direction from the corresponding sphere point to the closest collision point on collision body i, which in this example is represented as rᵢ. The values α₁ and α₂ can represent gain values and the value dᵢ=max(dₘᵢₙ, dᵢ) and can represent a positively lower-bounded distance, where dₘᵢₙ and dᵢ can represent a signed distance between the body sphere and the corresponding collision body i.

The base metric response M_{b} defined as shown can be made invariant to collisions count (e.g., number of collision bodies) by introducing the normalized metric

$${\hat{M}}_{b} = \frac{{M}_{b}}{‖ {M}_{b} ‖} .$$

In using the normalized metric \hat{M}_{b}, the Eigen-spectrum directionality can be preserved regardless of collision scenario complexity or sphere distribution. A base acceleration response can be defined as:

$${\ddot{x}}_{b} = - {\sum }_{i} \frac{1}{{\tilde{d}}_{i}} {\hat{n}}_{i}$$

In the above equation, \ddot{x}_{b} can represent the base acceleration response, \tilde{d}ᵢ can represent the minimal distance across collision bodies, where

$${\tilde{d}}_{i} = {min}_{i} \{ {d}_{i} \} .$$

acceleration response can provide collision-directed repulsion along the specific collision normal vector. Normalization of base acceleration response can be represented as

$${\hat{\ddot{x}}}_{b} = \frac{{\ddot{x}}_{b}}{‖ {\ddot{x}}_{b} ‖}$$

to facilitate unitary directionality for subsequent metric scaling. Both the normalized base metric and acceleration terms can be used to establish the following metric

$$M = \frac{β}{{\tilde{d}}_{i}^{2}} {\hat{M}}_{b}$$

for the geometric fabric 216. In equation for the metric M, the value β can correspond to a gain factor corresponding to the specifying relative metric scaling. The geometric acceleration can be represented as \ddot{x}=−k_{g}∥\ddot{x}_{b}∥²\ddot{\hat{x}}_{b}, where k_{g} can represent a gain value. The forcing acceleration can be represented as \ddot{x}=k_{ƒ}\hat{x}_{b}−b_{\dot{x}}, where k_{ƒ} can be a gain value and b can be a positive damping scalar. The geometric term can be tuned to dominate the collision avoidance behavior with speed invariant paths, while the forcing term can prevent penetration near the collision boundary.

To impose robot joint acceleration and jerk restrictions via the geometric fabric 216, such constraints can be explicitly represented as part of a second-order control formulation of the geometric fabric 216. Specifically, to derive joint acceleration constraints for the geometric fabric 216, the following quadratic optimization problem can be solved:

$$L = \frac{1}{2} {( {\ddot{q}}_{f} - \ddot{q} )}^{T} {M}_{f} ( {\ddot{q}}_{f} - \ddot{q} ) + \frac{α}{2} {{\ddot{q}}_{f}}^{T} {M}_{f} {\ddot{q}}_{f}$$

In the above equation, a can be a positive weighting factor, the vector \ddot{q}_{ƒ} can represent the acceleration output generated via the geometric fabric 216, the metric M_{ƒ} can encode a joint-space prioritization structure, and the term \ddot{q} can indicate the nominal desired joint acceleration. By defining the term \ddot{q}=(−M_{ƒ}+αI)⁻¹ƒ_{q}, a solution for the scalar factor α can be determined. For example, as α→∞, the computed geometric fabric acceleration magnitude can approach zero (∥\ddot{q}_{ƒ}∥→0). As a result, a single scalar α can be computed such that each joint acceleration remains beneath a predefined joint acceleration limit \ddot{q̅}ᵢ∀i, where i corresponds to a respective index for each respective joint of the robot. Adjusted joint acceleration limits, \ddot{q̅}, satisfying both original acceleration limits and specified jerk limits simultaneously, can be calculated. In some implementations, in computing the updated joint acceleration limits, adjusted joint acceleration constraints \ddot{q̅} can be calculated according to the following equation:

$$\overline{\ddot{q}} = min ( \overline{\ddot{q}} , \frac{Δ t \overline{\ddot{q}}}{2 \overline{\ddot{q}}} )$$

In the above equation, Δt can correspond to the integration timestep for performing integration of the geometric fabric 216 (e.g., using a second-order Runge-Kutta technique, etc.), the vector \ddot{q} indicates the original joint acceleration limits per join, and the vector \ddot{q̅} can represent the jerk limits. In performing such techniques, at each evaluation timestep of the geometric fabric acceleration \ddot{q}_{ƒ}, a scalar value of a can be calculated that satisfies the acceleration constraints and jerk limitations for all robot joints.

Positional joint limits within the geometric fabric 216 can be derived through introducing positional joint repulsion. In formulating positional joint constraints, upper joint limit task-space vectors can be defined as x=q̅−q, and lower joint limit task-space vectors as x=q−q. In these definitions, vectors q̅ and q can represent respective upper and lower positional joint limits, and the vector q can represent the current joint configuration. Within corresponding joint positional-limit task spaces, a geometric fabric metric can be defined as:

$$M ( x ) = diag ( max ( - sgn ( \dot{x} ) , 0 ) \frac{{k}_{b}}{x} )$$

In the above equation, the diagonal metric matrix M(x) can represent an assignment of increasing priority values in accordance with proximity to the positional joint limits, k_{b} can represent a predetermined constant gain factor. Using this positional-limit metric, corresponding geometric fabric accelerations within positional-limit task spaces can then be computed as:

$$\ddot{x} = g - b \dot{x}$$

In the above equation, the vector g can represent positional-limit repulsive acceleration magnitudes, the scalar b can represent a damping coefficient, and the vector \dot{x} can represent current joint velocities within the positional-limit task spaces. Based on such derived positional-limit accelerations, joint movements can be automatically directed away from imposed positional constraints via the geometric fabric 216, with increasing constraint enforcement prioritization as joints increasingly approach positional limits.

Using forward kinematics, positional trajectories of the sphere primitives assigned to the robot can be computed to enable collision detection between robot geometry and simulation environment components, including obstacles or simulated object geometries. Metrics for collision avoidance can be computed as functions of distances and relative velocities of sphere primitives relative to identified collision objects. In some implementations, such metrics can include velocity-gated responses that activate when approach velocities indicate impending collision and logarithmically scaled repulsive forces proportional to proximity values. In some implementations, joint positional constraints can be implemented by adding repulsive behaviors regarding joint range-of-motion limits. Such repulsive behaviors can be expressed as task-specific acceleration terms within the geometric fabric 216 to provide constraints that increase priority as joint configurations approach hardware-defined joint position boundaries.

The geometric fabric 216 can process control targets provided as inputs within action vectors 224 from the teacher model 220 by mapping the control actions into geometric task-spaces optimized for grasp behaviors. As described herein, PCA-based finger control action targets (e.g., x_{pca,target}) can be provided as part of the actions 224 within a PCA task-space derived using principal component analysis. Palm-position control targets (e.g., target palm positions x_{ƒ,target}) and palm-orientation targets (e.g., Euler angle values r_{ƒ,target}) can be mapped into a palm-fixed positional task-space to specify target positions for various points fixed relative to the palm of the simulated robot. Within such task-space representations, fabric acceleration terms can be implemented to encode target-directed attractors, causing geometric fabric 216 states to evolve toward specified PCA-based targets and palm configurations over discrete timesteps of the simulation 202A.

The action space for the robot, to be processed via the geometric fabric 216, can be established as a lower-dimensional manifold via retargeting of human grasping motion data to the robot. Principal component analysis can be applied to the motion dataset to establish the action space. To do so, an operator matrix A that includes, in one example, the first five principal components (or any other number of components, depending on configuration settings of the data processing system 102) derived from PCA can be defined. The taskmap from the full robot configuration space to the PCA space can be defined as x=Ãq∈ [symbol] ^{D}, where D is the number of dimensions in the PCA space, and Ã=[0, A]∈ [symbol] ^{D×N}, where N is the number of degrees of freedom of the robot. In some implementations, the robot can have 23 degrees of freedom.

Within the principal component analysis task space, an attraction fabric term can be defined. For example, a metric M(x)=mI can be defined, where m can be a constant scalar mass parameter and I is an isotropic identity matrix. Within such a configuration, the geometric fabric 216 can include a second-order acceleration formula described as

$$\ddot{x} = - {k}_{a} \cdot tanh ( {α}_{a} ‖ x - {x}_{pca , target} ‖ ) \frac{x - {x}_{pca , target}}{‖ x - {x}_{pca , target} ‖} - b \dot{x} ,$$

in which the parameters kₐ and αₐ can correspond to scalar gain terms, and x_{pca,target} can represents a target position within the PCA task space, as described herein. Application of this attraction fabric term can accelerate convergence toward the specified target positions within the PCA task space. As a result, the PCA task space can represent the action space for finger control tasks of the geometric fabric 216.

To coordinate control of the robot fingers and robot palm positions, an additional action space can be introduced to govern the pose of the robot palm. A taskmap for this additional action space can be defined according to forward kinematics, resulting in a mapping from robot configuration space to three-dimensional points fixed relative to the palm. In some implementations, at least seven three-dimensional points fixed to the palm can be used. In some implementations, the three-dimensional points can be concatenated to establish a 21-dimensional palm-space representation. The geometric fabric 216 operating within such palm-space representations can be established to apply a similar attraction fabric formulation as described above in relation to the finger control space.

For example, a palm attraction acceleration within the geometric fabric 216 across an example 21-dimensional palm-space can be represented by

$$\ddot{x} = - {k}_{a} \cdot tanh ( {α}_{a} ‖ x - {x}_{g} ‖ ) \frac{x - {x}_{g}}{‖ x - {x}_{g} ‖} - b \dot{x} ,$$

in which kₐ and αₐ can represent scalar gain parameters and x_{g} can correspond to the target pose for the palm-fixed points across the example 21-dimensional space. In some implementations, to avoid operating with a full higher-dimensional taskmap as an action space, the action space for the palm can be reduced to a smaller-dimensional representation, such as a six-dimensional representation. In such implementations, at least three translational positions and at least three Euler angles defining robot palm orientation can represent the palm action space. The geometric fabric 216 can transform the reduced-dimensional action representation into the corresponding full 21-dimensional space of seven palm-fixed three-dimensional points, x_{g}, prior to application of the fabric attraction acceleration formula described above. In some implementations, the geometric fabric 216 can implement a five-dimensional PCA-based finger action space and a six-dimensional palm action space, thereby defining the action space for the full robot configuration can be defined as an 11-dimensional action space.

As described herein, the finger action space for the robot can be defined as via PCA on the finger joint motions of the robot derived from retargeting human grasping data. To do so, various datasets of 3D point motion traces of human fingertips, joints, and palm positions of humans throughout object grasping trials can be used. In some implementations, finger data from the dataset can be scaled (e.g., via a scaling factor α, which may be equal to 1.6 in some implementations, or any other suitable scaling factor) and aligned to the fingertip points of the robot. To perform retargeting, human fingertip trajectories can be expressed in a coordinate frame compatible with the robot that can be defined using palm-fixed reference points. Corresponding optimization parameters, initialized at zero values, can be solved for an optimized robot joint configuration that reproduces the human fingertip positions. Optimization can be performed sequentially through each data point in a given motion trace, iteratively determining a joint configuration that aligns simulated robot fingertip positions with human data points.

To optimize joint configurations of the robot hand, a loss term [symbol] can be minimized during each iteration. The loss function [symbol] can be defined to guide the optimization between precision and power grasp shapes. The loss function employed during optimization can be provided via the following equation:

$$( q ) = γ {‖ {x}_{r} - α {x}_{h} ‖}^{2} + ( 1 - γ ) {‖ {x}_{r} - {x}_{c} ‖}^{2} + λ ‖ {q}_{r} - {q}_{reg} ‖$$

In the above equation, the term x_{c}=[\tilde{x}^{T}, \tilde{x}^{T}, \tilde{x}^{T}, \tilde{x}^{T}]^{T} can represent a vector formed by repeating a single 3D positional point x four times, which can operate as a focal point for grasp shape adjustment. The point \tilde{x} itself can be positioned variably to encourage shaping of the grasp either toward precision or power configuration. For example, placement of the single point on a central plane of the simulated robot palm can result in digit trajectories that favor curling into a power grip. In another example, positioning the point centrally among the simulated robot fingertips can provide a grasp orientation targeted toward precision grasping shapes.

The vector xᵣ can represent predicted hand configurations during optimization. The term qᵣ can represent optimized join angles from which the vector xᵣ may be computed. The parameter xₕ can represent observed human fingertip locations within the retargeted grasp trajectory. The factor γ can be a blend factor, where

$$γ = 1 - \frac{i + 1}{n}$$

(with i being the index and n being the total data length), can be used to dynamically shift the optimization during a retargeting trace. For example, at an initial data point within the trajectory, the blend factor can fully focus on aligning digit positions xᵣ with human data positions xₕ. As the optimization process proceeds toward later data points, the blend factor can cause the optimization to transition toward matching simulated digit positions with the chosen centralized positional target, thereby favoring either precision or power shape.

The regularization term λ∥qᵣ−g_{reg}∥ can be used to provide selective bias of joint configurations qᵣ toward predetermined shape configurations represented as q_{reg}. The target-valued vector q_{reg} can encode digit joint angle arrangements associated with target grip configurations. In an example where q_{reg} specifies a configuration for a precision grip, the vector g_{reg} can take a value of [0,0,0,0,0,0,0,0,0,0,0,0,1.0,0.75,0,0] imposing a simulated robot shape with extended fingers and a thumb opposition posture. In another example, when targeting a power grip arrangement, the vector g_{reg} can be set as [0,1,1,1,0,1,1,1,1,1,1,1,1,0.75,0,0], resulting in fully curled simulated finger joints along with an opposed thumb posture. Other configurations of G_{reg} are also possible to target different grip or finger position configurations.

Following sequential retargeting iterations for the human motion trajectory dataset, optimized simulated digit joint angle trajectories can be used to generate a training dataset for computing a PCA-based representation. By applying PCA to the generated joint angle retargeting dataset, a rectangular projection matrix of dimension D can be obtained, which can capture dominant variance directions of hand motion with respect to the robot. In one example, selecting five principal eigenvectors may capture a sufficient amount (e.g., 98 percent, etc.) of the variance of the retargeted dataset, thereby defining an effective 5-dimensional PCA action space. The resulting PCA projection matrix A can be used as a taskmap to map the geometric fabric 216 input actions into a concentrated space for grasping behaviors. Actions 224 generated within the resulting PCA task-space can be translated into full joint space configurations via the geometric fabric 216 to control the simulated robot grasping during subsequent reinforcement learning processes described herein.

In some implementations, the geometric fabric 216 can be executed to generate joint proportional-derivative targets 226 by numerically integrating fabric acceleration terms using a second-order integration scheme (e.g., a second-order Runge-Kutta technique, etc.), resulting in updated fabric states including positions and velocities. Updated fabric states can be provided to joint PD control loops of the simulation 202A for simulated robot as joint positions and velocities to define next-step motion trajectories toward specified PCA-based finger and palm targets. In some implementations, the integration processes can execute at a predetermined simulation-update frequencies (e.g., 60 Hz, 120 Hz, etc.). In some implementations, the simulation-update frequency can be different than the action-generation rates (e.g., actions 224 can be generated/provided at 15 Hz). In such implementations, each generated action 224 can be held constant and effectuated repeatedly across multiple timesteps of the simulation 202A.

The model trainer 108 can repeat the generation of actions 224 across multiple iterations of multiple simulations 202A to train/update the critic model 218 and the teacher model 220. The model trainer 108 can repeat the generation of actions 224 across multiple iterations of multiple simulations 202A to train/update the critic model 218 and the teacher model 220 until a termination condition is satisfied. In some implementations, the termination condition can be satisfied upon achieving a predetermined cumulative reward threshold calculated using the reward functions described herein. In some implementations, the termination condition can be satisfied upon completing a preset maximum number of training/update iterations. In some implementations, the termination condition can be satisfied upon determining that performance of the teacher model 220 exceeds a predetermined success rate, which may be indicated by the reward value r_{success} over one or more simulation episodes.

Referring back to FIG. 1, once the model trainer 108 has completed the first stage of the training/update process, the teacher model 112 can be used to train/update the student model 110 in a second stage of the training/update process. To perform the second stage of the training/update process, the simulation initializer 104 may initialize additional simulations 113 including a simulated environment having one or more simulated robots 114 and one or more simulated objects 116. The second phase of the training/update process can be used to distill the performance of the teacher model 112 into the student model 110, while training/updating the student model 110 to predict an action for the simulated robot 114 to grasp the simulated object 116 and to predict a position of the simulated object 116 in the simulation. Rather than relying on the same information provided to the teacher model 112, the student model 110 can be trained/updated to generate predictions based on simulated depth images. Further details of the second stage of the training/update process are described in connection with FIG. 2B.

Referring to FIG. 2B in the context of the components described in connection with FIGS. 1 and 2A, depicted is block diagram 200B showing an example data flow for training/updating a student model 230 (e.g., the student model 110) for implementing dexterous grasping with geometric fabrics 216, in accordance with some embodiments of the present disclosure. The diagram 200B shows at least one simulation 202B, which can provide noisy object pose data 208, object identifier(s) 210, proprioception data 212, and/or goal position data 214 as input to the teacher model 220 (e.g., following the first stage of the training/update described in connection with FIG. 2A). The simulation 202B is shown as providing depth image(s) 213, the proprioception data, and the goal position data 214 as input to the student model 230. The simulation can provide object position data 228 for use in determining a position loss 234, as described in further detail herein.

The teacher model 220 can be trained/updated, for example, by the model trainer 108 using the first stage described in connection with FIG. 2A. Once trained/updated, the trainable parameters of the teacher model 220 can be held constant during the second stage of the training/update process (e.g., as indicated by the frozen symbol). As described herein, the teacher model 220 can generate predicted actions for the simulated robot (e.g., the simulated robot 114) in the simulation 202B. As shown, the predicted actions can be used to generate an action loss based at least on the actions 224 generated by the student model 230.

The simulation 202B can be similar to, and/or can include any of the structure and functionality of, the simulation 202A of FIG. 2A and/or the simulation 113 of FIG. 1, and vice versa. The simulation 202B can be initialized by the simulation initializer 104 using parameters specific to the second training/update stage for the student model 110, in some implementations. The simulation 202B can include a simulated robot (e.g., the simulated robot 114) and a simulated object (e.g., the simulated object 116) positioned within a three-dimensional simulated environment, along with environmental physics properties such as friction coefficients, collision tolerances, or gravity values, among others, as described herein. The simulation 202B to execute physics-based computations at a predetermined simulation rate (e.g., 60 Hz, 15 Hz, etc.) to update the state of the simulated robot and simulated object at discrete time steps.

During execution, the simulation 202B can provide real-time access to simulation state data, including object position data 228, robot configurations, and proprioception data 212, to the model trainer 108. In some implementations, the simulation initializer 104 can randomize parameters such as object geometries, lighting conditions, or joint constraints of the simulated robot to improve robustness of the student model 230. The simulation 202B can be synchronized with operations of the model trainer 108 by transmitting updated simulation state data at intervals corresponding to the training/update rate of the student model 230.

The model trainer 108 can generate one or more depth images 213 capturing depth information of the simulated environment of the simulation 202B. The depth images 213 can represent three-dimensional depth data of the simulated robot, simulated object, and surrounding environment within the simulation 202B. Each depth image 213 can be constructed via depth 3D rendering techniques that map distances from a virtual camera viewpoint to various surfaces and object geometries within the simulated environment. The depth images 213 can be formatted as raw depth data matrices indicating depth values across an array of pixel locations, in some implementations. Such depth data matrices can encode pixel-wise depth metrics from the virtual camera viewpoint to corresponding points in the simulated scene, facilitating representation of the spatial distribution of objects and environmental components within the simulation 202B. Depth image generation within the simulation 202B can involve ray-casting or depth-buffering operations that compute per-pixel depth values based on camera viewpoint and scene geometry projections.

In some implementations, each depth image 213 can be formed by executing one or more depth-rendering processes using a predetermined depth-capturing camera model within the three-dimensional simulated environment of the simulation 202B. The depth-rendering camera can be positioned to capture depth maps from specific viewpoints, such as on a simulated robot or located strategically within the simulated environment to ensure comprehensive scene coverage. The depth images 213 can be updated at fixed intervals corresponding to predetermined simulation timestep rates (e.g., 60 Hz, 15 Hz, etc.), providing depth updates synchronous with changes to the state of the simulation 202B. In some implementations, depth images 213 can be processed to introduce depth noise (e.g., uncorrelated noise, etc.).

The student model 230 can be similar to, and include any of the structure and implement any of the functionality of, the student model 110 of FIG. 1, and vice versa. The student model 230 can include multiple layers to process different types of input data and generate predictions for dexterous grasping tasks. For example, the student model 230 can include one or more convolutional layers that can receive one or more depth images 213 (shown in FIG. 2B, and sometimes referred to here as, “I”) as input, one or more MLP layers that can receive the proprioception data 212 (shown in FIG. 2B, and sometimes referred to here as, “o_{robot}”) and goal position data 214 (shown in FIG. 2B, and sometimes referred to here as, “x_{goal}”) as input, and one or more RNN layers that receive the outputs of the one or more convolutional layers and the one or more MLP layers. In some implementations, the student model 230 can include three MLO with elu activation functions. In one example, the three MLP layers can have sizes of 512, 256, and 128. In some implementations, the one or more RNN layers can include gated recurrent unit (GRU) layers, for example, with 1024 units.

During the second stage of the training/update process, the student model 230 can be trained/updated to generate predicted actions 224 (sometimes referred to as â) and predicted object positions 236 (sometimes referred to as \hat{x}_{obj}) based on the depth images 213, the goal position data 214, and the proprioception data 212. The model trainer 108 can execute the student model 230 to generate the generate predicted actions 224 and the predicted object position 236, which can be used to generate the action loss 232 and the position loss 234, respectively. The action loss 232 and the position loss 234 can be combined to generate a total loss, which can be used to train/update the parameters of the student model 230. In one example, the total loss can be represented via the following equation:

$$L = {L}_{action} + β {L}_{pos}$$

In the above equation, L can correspond to the total loss used to train/update the student model 230, L_{action} can correspond to the action loss 232, Lₚₒₛ can correspond to the position loss 234, and β can be a scaling factor (e.g., 0.1 in some implementations, etc.). In one example, the action loss 232 can be represented as L_{action}=∥â−a∥₂, where a is equal to the action output of the teacher model 220. In another example, the position loss 234 can be represented as Lₚₒₛ=∥\hat{x}_{obj}−x_{obj}∥₂, where x_{obj} corresponds to the object position data 228 generated via the simulation 202B. As shown, the predicted actions 224 of the student model 230 can be provided as input to the geometric fabric 216, which can be used to generate joint PD targets 226 for the simulated robot, as described in connection with FIGS. 1 and 2A.

In some implementations, the simulation-update frequency can be different than the action-generation rates (e.g., actions 224 can be generated/provided at 15 Hz). In such implementations, each generated action 224 can be held constant and effectuated repeatedly across multiple timesteps of the simulation 202B. The model trainer 108 can use the total loss to update the parameters of the student model 230 using a suitable optimization function (e.g., gradient descent, Adam optimizer, etc.) and backpropagation techniques. The model trainer 108 can repeat the generation of actions 224 across multiple iterations of multiple simulations 202B to train/update the student model 230 until a termination condition is satisfied. In some implementations, the termination condition can be satisfied upon completing a preset maximum number of training/update iterations. In some implementations, the termination condition can be satisfied upon determining that performance of the student model 230 exceeds a predetermined success rate. In some implementations, the termination condition can be satisfied upon determining that the total loss has plateaued to a certain degree (e.g., has not changed beyond a certain threshold for a predetermined number of iterations, etc.).

Referring back to FIG. 1, once the model trainer 108 has completed the second stage of the training/update process, the student model 110 can be used to control the physical robot 120 via the geometric fabric controller 106 using depth images provided from one or more capture devices 118 and sensor signals from the physical robot 120. The depth images can be captured by the capture devices 118 in real-time or near real-time. The depth images can depict the environment in which physical robot 120 and the physical object 122 are positioned. Sensor data from the physical robot can include proprioception data similar to the proprioception data 212 of FIGS. 2A and 2B, resulting from real-world forces experienced by the physical robot 120.

The capture devices 118 can include any type of device that can capture depth images and/or color red-green-blue (RGB) images. For example, the capture devices 118 may include Light Detection and Ranging (LiDAR) sensors, stereo camera systems, time-of-flight (ToF) cameras, or structured-light sensors, among others. In some implementations, stereo camera systems can use two or more spatially offset cameras that can simultaneously capture images of the same environment from slightly different perspectives, which can then be processed to calculate depth information based on stereo disparity. In some implementations, LiDAR sensors can measure time-of-flight values of laser pulses emitted towards the environment to determine precise depth information for the environment including the physical robot 120 and the physical object 122.

In some implementations, the capture devices 118 can be subject to calibration procedures, including extrinsic calibration for estimating camera or sensor poses relative to a known reference frame, and intrinsic calibration to characterize device-specific parameters (e.g., distortion coefficients, optical properties), which may be specific to the physical robot 120, the physical object 122, and/or the environment. Such calibration procedures can involve capturing images or signals of calibration targets that have predefined geometry to accurately measure and correct the output of the capture devices 118.

The physical robot 120 can include a dexterous robotic manipulator to implement various fine motor operations, such as a robotic hand with articulated fingers, a multi-jointed robotic gripper, or a robotic arm outfitted with manipulable end-effectors, among others. In some implementations, the physical robot 120 can include a four-fingered robotic hand equipped with multiple individually actuated joints and degrees-of-freedom to perform human-like grasping and object manipulation. The physical robot 120 can communicate with the data processing system 102 using wired or wireless communication interfaces. In some implementations, the physical robot 120 can include embedded processors or control electronics that receive control instructions (e.g., joint position targets, control torques, velocity commands, etc.) from the data processing system 102 (e.g., generated via the geometric fabric controller 106) to translating such instructions into joint movements using onboard actuators, servos, or motor controllers, among others.

The physical object 122 can include various items selected for manipulation within a grasping task, including rigid components, deformable materials, irregularly shaped objects, or delicate and easily damaged items, among others. In some implementations, the physical object 122 can include industrial articles such as manufactured parts, electronic components, packaged product containers, or tools, among others. In other implementations, the physical object 122 can include household items, food items, soft goods, or heterogeneous articles comprising multiple materials and geometries, among others. The geometric fabric controller 106 and the student model 110, when executed by the data processing system 102, can generate control instructions for the physical robot 120 to perform dexterous grasping tasks based on depth images or stereo image inputs capturing the physical object 122 and the surrounding environment. In some implementations, the simulated object 116 used within the simulation 113 can represent a virtual version of the physical object 122. Further details of the process via which the student model 110 is executed to control the physical robot 120 to manipulate the physical object 122 are described in connection with FIG. 2C.

Referring to FIG. 2C in the context of the components described in connection with FIGS. 1, 2A, and 2B, depicted is block diagram 200C showing an example data flow for controlling a robot in a physical environment 242 (e.g., the physical robot 120) for implementing dexterous grasping with respect to physical objects (e.g., physical objects 122, etc.), in accordance with some embodiments of the present disclosure. The data processing system 102 can communicate with the robot 424 and capture devices (e.g., the capture devices 118) to receive proprioception data 212 and captured depth images 233, respectively.

As described herein, capture devices (e.g., the capture devices 118) can capture depth images 233 of the robot in the physical environment 242, including depictions of any physical object and surrounding spaces. In some implementations, the capture devices generate raw depth measurements that are formatted into structured depth images 233, which can encode distances from the capture devices to surfaces within the observed environment. The capture devices can transmit captured depth images 233 to the data processing system 102 at predetermined update frequencies or frame rates (e.g., 30 frames-per-second, 60 frames-per-second, or 120 frames-per-second, etc.).

The robot 242 can include sensors that can measure proprioception data 212 representing robot-specific internal state information, such as joint angles, actuator positions, joint torques, motor velocities, grip forces applied by end-effectors, temperature readings from actuators, or status indicators of robot components, among others. In some implementations, encoder devices integrated into individual joints or robot actuators can measure rotational or translational displacement and can generate respective proprioception data 212 representing measured joint position or velocity values. Various sensors that may be coupled to or included as part of the robot 242 may include strain gauges, torque sensors, or force-sensitive resistors, among others. Such sensors may be integrated within articulated joints or end-effectors of the robot 242 and can measure forces applied to or exerted by the robot joints, which may be provided as proprioception data 212 indicative of interaction dynamics with the environment and any grasped objects. The proprioception data 212 generated by sensors of the robot 242 can be transmitted to the data processing system 102 via wired or wireless communication channels at predetermined data rates, in some implementations.

The goal position data 214 may be a predetermined or dynamically determined position at which any detected objects are to be positioned via manipulation using the robot 242. To maneuver objects into the goal position 214, the data processing system 102 can provide the capture depth images 233, the proprioception data 212, and the goal position data 214 as input to the student model 230 (e.g., the student model 110). The data processing system 102 can execute the student model 230, which can process the received inputs to compute predicted position data 236 representing one or more predicted positions of the physical object 122. In some implementations, the data processing system 102 can preprocess inputs provided to the student model 230, such as aligning the depth images 233 and proprioception data 212 onto synchronized timestamps.

The student model 230 can generate predicted object position data 236 for the object(s) and control actions 224 for maneuvering or grasping one or more objects. The control actions 224 generated by the student model 230 can include actions mapped of the action space described in connection with FIG. 2A. The actions 224 and the predicted position 236 can be provided as input to the state machine 238, in some implementations. The state machine 238 can be used to determine a state of the object based on the predicted object position 236. For example, the state machine 238 can be used to determine whether the object has been grasped, is being transported, or has reached a goal position. In some implementations, the state machine 238 may be defined based at least on configuration settings for a particular application, such that manipulation of the objects in the environment can be controlled to perform one or more tasks such as bin packing or other industrial/manufacturing applications.

In some implementations, certain states of the state machine 238 may cause generation of one or more output actions 240 to release an object (e.g., if the object is positioned at a goal position, etc.), to reinitialize the robot to an initial state or default configuration, or to provide the actions 224 generated by the student model 230 as the output actions 240. As shown, the output actions 240 can be provided as output to the geometric fabric 216 (e.g., the geometric fabric controller 106, etc.). As described herein, the data processing system 102 can execute the geometric fabric controller 106 to translate the output actions 240 into joint PD targets 226 for the robot in the physical environment 242. The data processing system 102 may execute the student model 230 in real-time or near-real-time, at a predetermined inference rate (e.g., approximately 15 Hz, etc.). The state machine 238 can control which actions are provided as output actions 240 to the geometric fabric 216 to enforce completion of target grasping or manipulation tasks.

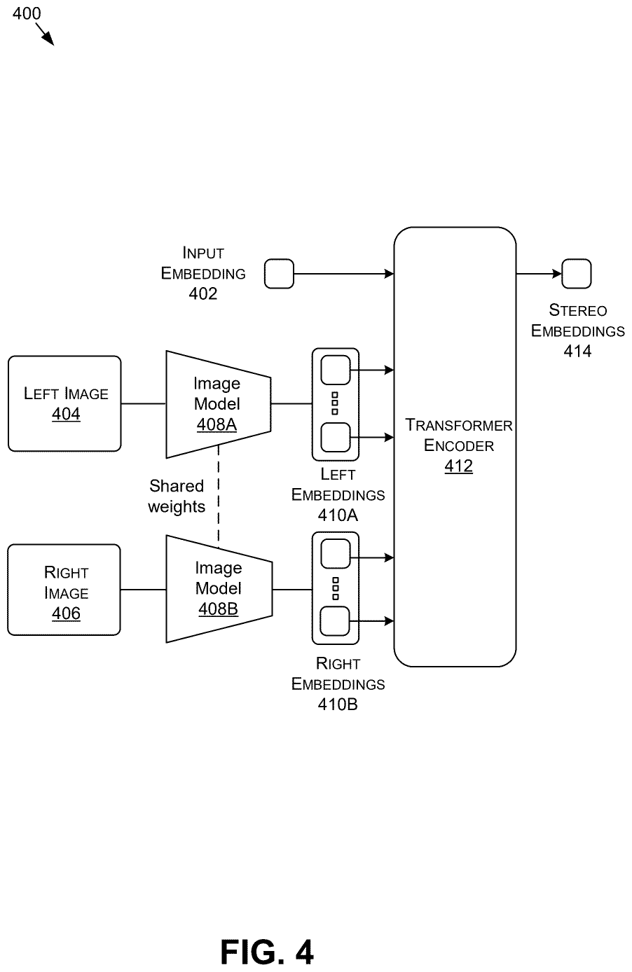

Referring back to FIG. 1, in some implementations, the data processing system 102 may train/update the student model 110 using one or more stereo image pairs captured via capture devices 118. For example, rather than relying on depth images or depth maps derived from data generated by the capture devices 118, the data processing system 102 may implement a student model 110 that includes an encoder (e.g., the transformer encoder 412 of FIG. 4) to process color-based visual inputs. In doing so, the data processing system 102 can train/update the student model 110 to control the physical robot 120 even under challenging or varied light exposures, or other circumstances that may impact the performance of depth-based sensors.

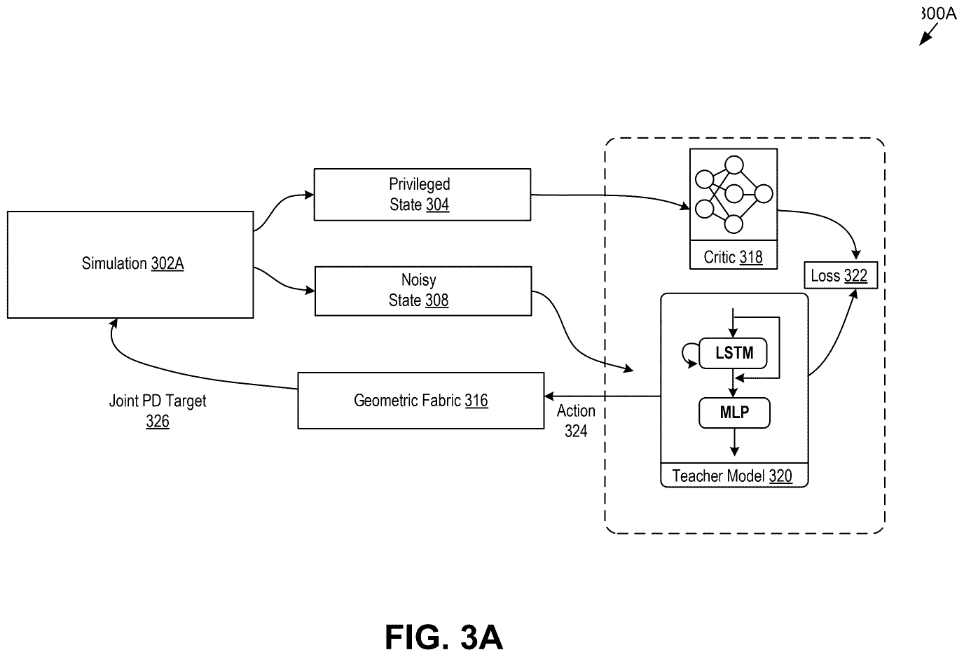

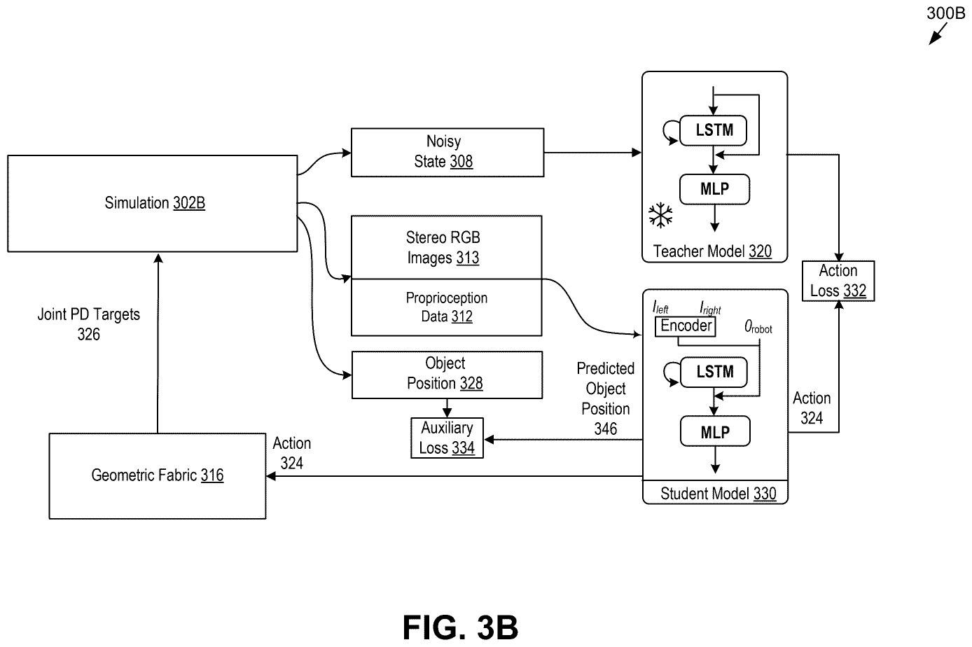

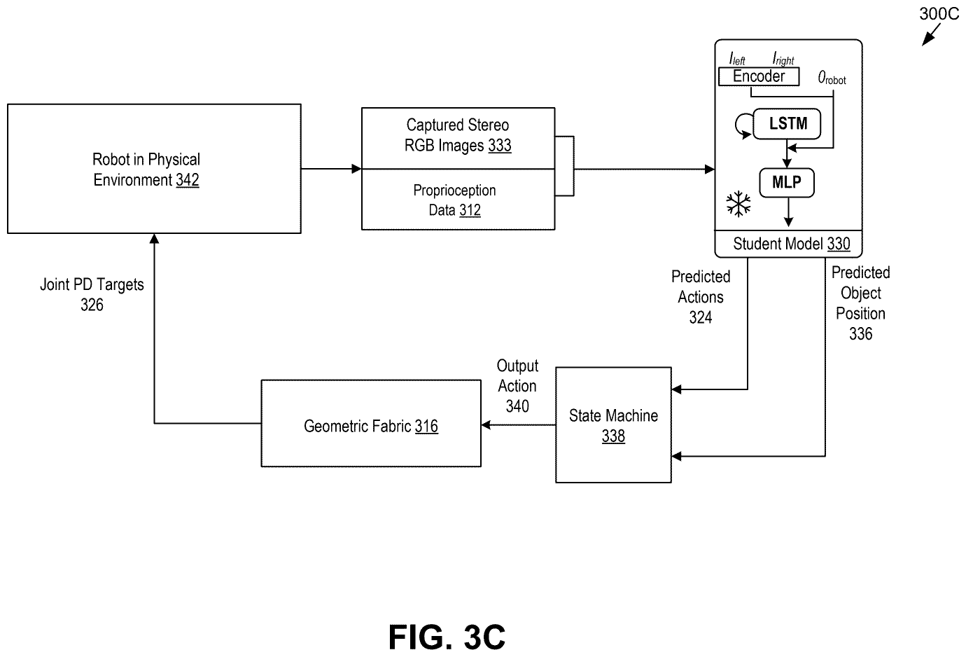

In such implementations, the student model 110 may include a stereo-encoder that can process at least two color-based images as input, thereby implicitly inferring depth information from the images. By training/updating the student model to automatically process input images to implicitly process depth data, the student model 110 can be updated/trained generate robot manipulation actions that generalize effectively to novel objects having previously unseen textures, reflectivity, transparency, or shapes, resulting in improved real-world operational robustness and flexibility relative to other robotic grasping approaches. Further details of a multi-stage training/update process for the teacher model 112 and the student model 110 to process color-based images are described in connection with FIGS. 3A, 3B, and 3C.

Referring to FIG. 3A, illustrated is a data flow diagram 300A showing a first stage/phase of a training/updating process for the student model 110 of FIG. 1, in accordance with some embodiments of the present disclosure. In the first stage of the training/update process, the teacher model 320 can be trained/updated using techniques similar to those described in connection with FIG. 2A. The diagram 300A shows an example simulation 302A that can provide privileged state data 304 and noisy state information 308, a geometric fabric 316, a critic model 318 and a teacher model 320.

The simulation 302A can be initialized, for example, by the simulation initializer 104 to include at least one simulated robot (e.g., simulated robot 114) and at least one simulated object (e.g., simulated object 116) in a simulated three-dimensional environment. The first stage/phase of the training/update process can be similar to the first stage/phase of the training process described in connection with FIG. 2A. The simulation 302A can be initialized to include a three-dimensional simulated environment containing at least one simulated robot and at least one simulated object. In some implementations, the simulated environment may include the simulated robot and/or simulated object being positioned on a simulated surface, for example, a simulated table surface. The simulated robot can have multiple degrees of freedom, as described herein. The simulated object may include one or more virtual meshes/textures/materials selected from sets of geometric shapes, such as various items having varying dimensions, curvatures, shapes, surface irregularities, reflections, or transparency characteristics, among others. The simulation 302A can execute physics-based computations at a predetermined simulation-update rate (e.g., 120 Hz, 60 Hz, etc.) to update simulation states, including positions, velocities, accelerations, or collision forces, among others, at discrete timesteps.

The simulation 302A can generate privileged state information 304 that provides precise numerical data describing internal simulation states, including data that might remain inaccessible or difficult to measure with real-world sensors. The privileged state information 304 can be similar to, and include any of the data described in connection with, the perfect state data 204, force data 206, proprioception data 212, object identifier(s) 210, and/or goal position data 214 as described in connection with FIGS. 2A-2C. For example, the privileged state information 304 may include, but is not limited to, joint position data, joint velocity states, fingertip positions of the simulated robot, palm positions and orientations, object pose data such as position and orientation quaternions, object linear velocities, or angular velocities, and measured forces and torques at various points of simulated robot-object contact. The privileged state information 304 can be provided as input to the critic model 318, as described herein.

The simulation 302A can generate noisy state information 308 used as input to the teacher model 320. The noisy state information 308 may include noisy or biased estimates of simulation states intended to approximate sensor measurement imperfections experienced within real-world applications. The noisy state information 308 can be derived by combining accurate simulation state variables with added correlated and/or uncorrelated noise sampled from statistical distributions, such as Gaussian distributions. In some implementations, the model trainer 108 may generate noisy object pose measurements within the noisy state information 308 that can include a sum of the exact simulated object position and one or more noise contributions. The noise contributions may include uncorrelated Gaussian noise that updates at each simulation timestep and correlated Gaussian noise sampled at the start of each simulation episode and maintained constant during the simulation episode, as described herein. In some implementations, similar noise generation processes can be applied to various other aspects of the state of the simulation. In some implementations, the noisy state information 308 can include one or more of the noisy object pose 208, object identifiers 210, proprioception data 212, and/or goal position data 214, as described in connection with FIGS. 2A-2C.

In some implementations, model trainer 108 can implement one or more automatic domain randomization functions for the simulation 302A (e.g., across episodes, across multiple simulations, etc.). The one or more automatic domain randomization functions can be used to alter physical and/or visual parameters throughout the training/update for the teacher model 320. Such physical parameters can include friction coefficients between simulated objects and surfaces, collision restitution coefficients, disturbances and forces on the simulated object, robot joint friction coefficients and proportional-derivative stiffness or damping terms, or object masses, among others. In some implementations, the automatic domain randomization functions can incrementally vary one or more of such parameters within predetermined initialization and terminal randomization ranges, such that the complexity and variability of simulation scenarios increase with improved teacher model 320 capacities.

The model trainer 108 can train/update the critic model 318 and the teacher model 320 using a similar training/update process as described in connection with FIG. 2A. The critic model 318 can be similar to, and implement any of the structure and/or functionality of, the critic model 218 of FIG. 2A. In some implementations, the critic model 318 can include one or more LSTM layers and one or more MLP layers. In one example, the critic model 318 can include a 2048 unit LSTM network and an MLP with [1024, 512] units. Furthering this example, in some implementations a skip connection may be added around the LSTM before passing through the final readout layer. The critic model 318 and the teacher model 320 can be trained/updated using a PPO loss 322, which may be calculated using similar operations to those described in connection with the loss 222 of FIG. 2A.

During the first training/update stage, the model trainer 108 can train/update the teacher model 320 to generate actions 324 for geometric fabric 316 associated with the simulated robot of the simulation 302A using the noisy state information 308. The actions 324 can be similar to the actions 224 described in connection with FIGS. 2A-2C. The teacher model 320 may be similar to, and implement any of the structure and/or functionality of, the teacher model 220 of FIGS. 2A and 2B. In some implementations, and as shown in the diagram 300A, the teacher model 320 can include one or more LSTM layers followed by one or more MLP layers. In one example, the teacher model 320 can include a 512 LSTM layer followed by two MLP layers of 512 units. Furthering this example, the teacher model 320 can include a skip connection around the LSTM layer(s), in some implementations.

The geometric fabric 316 (e.g., the geometric fabric controller 106) can be similar to, and implement any of the structure and functionality of, the geometric fabric 216 of FIGS. 2A-2C. As described herein, the geometric fabric 316 can translate input actions 224 into joint PD targets 326, which can be used to control the simulated robot to perform movement/gasping/manipulation tasks. The simulation 302A can use the generated joint PD targets 326 to update the simulation state at a predetermined update rate. For example, the simulation 302A may update at a rate of 120 Hz, while the teacher model 320 may generate output at a different rate, such as 60 Hz.

The model trainer 108 can use similar asymmetric actor-critic training/update processes as those described in connection with FIG. 2A to train/update the critic model 318 and the teacher model 320. In some implementations, additional or alternative reward terms can be implemented rather than using any or all of the reward terms described in connection with FIG. 2A. For example, one reward term can be described in connection with d_{hand_obj}, which can represent the maximum distance between any point on the simulated robot (e.g., four positions of the fingertip and one position for the palm, etc.) and the simulated object. In one example, d_{hand_obj} can be defined as

$${d}_{hand \_ obj} = {max}_{i ∈ \{ palm \_ pos , fingertips \}} ‖ {x}^{i} - {x}^{obj} ‖ ,$$

where x_{obj} is the position of the simulated object, xⁱ is the position of a respective point on the simulated robot (e.g., one the positions of each fingertip and one position for the palm, etc.). The corresponding reward function relating to d_{hand_obj} can be defined as r_{hand_obj}=exp(−10·d_{hand_obj}), in one example implementation.

In another example, a reward term corresponding to a distance between the position of the object and the goal position may be provided. In some implementations, such a reward term may be provided as r_{obj_goal}=exp(−β_{obj_goal}·∥x^{obj}−x^{goal}∥), where x^{goal} is the goal position and β_{obj_goal} can be a positive scalar gain parameter. An example reward term corresponding to lifting the simulated object using the simulated robot can be defined as

$${r}_{lift} = exp ( - {β}_{lift} \cdot {( {x}_{z}^{obj} - {x}_{z}^{goal} )}^{2} ) ,$$

where z corresponds to the vertical direction and β_{lift} corresponds to a positive scalar gain parameter. An example regularization reward term to prevent fingers from curling too much can be defined as r_{curl}=−β_{curl}·∥q_{hand}−q_{curl}|², where q_{hand} corresponds to the current configuration of the hand, q_{curl} corresponds to a curled configuration for the hand, and β_{curl} corresponds to a positive scalar gain parameter. The foregoing reward functions can be combined into a total reward function for training/updating the teacher model 320, which may be provided as r=w_{hand_obj}r_{hand_obj}+w_{obj_goal}r_{obj_goal}+w_{lift}r_{lift}+w_{curl}r_{curl}, where each w parameter corresponds to a respective weight for each of the example reward functions.

As described herein, in some implementations, automatic domain randomization can be applied to episodes of the simulation 320A as the teacher model 320 improves in performance (e.g., as the loss decreases, etc.). The model trainer 108 can implement automatic domain randomization during training or updating of the teacher model 320 by applying scaling operations to velocity targets provided to a proportional-derivative controller. In some implementations, the model trainer 108 can scale velocity target inputs from an initial maximum value of 1 to a zero value, thereby conditioning the teacher model 320 to learn policies relying exclusively on position-based dynamics. For example, when non-zero velocity targets are initially employed, the teacher model 320 can experience faster dynamic robot responses, facilitating reinforcement learning exploration. In some implementations, the model trainer 108 can further scale velocity and acceleration inputs supplied to the teacher model 320 from initial values of 1 to a final value of 0. The model trainer 108 can perform such scaling operations such that the teacher model 320 can use recurrent capacity to reason effectively over position-only input dynamics and does not rely on higher-order estimated state values or signals.

In some implementations, the model trainer 108 can implement automatic domain randomization by modifying simulation timing and simulation damping parameters during training/updating of the teacher model 320. For example, the model trainer 108 may time-integrate the differential equation of the geometric fabric 316 for two simulation timesteps at each individual simulation step, thereby increasing the speed of motion experienced by the teacher model 320. In addition, the model trainer 108 can adjust the fabric damping parameter during simulation from an initial value (e.g., an initial value of 10) to an increased value (e.g., an increased value of 20). In some implementations, the model trainer 108 can further apply modified control logic to disturbance wrenches affecting grasped simulated objects during various episodes of the simulation 302A. For example, the model trainer 108 can cause the disturbance wrenches to activate when the hand of the simulated robot is within a predetermined distance from the center of the simulated object. The implementation of such activation logic provides that simulated grasped objects begin moving prior to hand closure, such that the teacher model 320 can be trained/updated to respond with reactive grasping policies.

The model trainer 108 can iteratively train/update the teacher model 320 according to the techniques described herein until a termination condition is satisfied. In some implementations, the termination condition can be satisfied upon achieving a predetermined cumulative reward threshold calculated using the reward functions described herein. In some implementations, the termination condition can be satisfied upon completing a preset maximum number of training/update iterations. In some implementations, the termination condition can be satisfied upon determining that performance of the teacher model 220 exceeds a predetermined success rate or total reward value.

Referring back to FIG. 1, once the model trainer 108 has completed the first stage of the training/update process, the teacher model 112 can be used to train/update the student model 110 in a second stage of the training/update process, which can involve training/updating using color-based images. To perform the second stage of the training/update process, the simulation initializer 104 may initialize additional simulations 113 including a simulated environment having one or more simulated robots 114 and one or more simulated objects 116. The second phase of the training/update process can be used to distill the teacher model 112 into the student model 110, as described herein. Rather than relying on the same information provided to the teacher model 112, the student model 110 can be trained/updated to generate predictions based on color-images via one or more encoder layers, which are described in further detail in connection with FIG. 4. Further details of the second stage of the training/update process are described in connection with FIG. 3B.

Referring to FIG. 3B in the context of the components described in connection with FIGS. 1 and 3A, depicted is block diagram 300B showing an example data flow for training/updating a student model 330 (e.g., the student model 110) using stereo RGB images 313, in accordance with some embodiments of the present disclosure. The diagram 300B shows at least one simulation 302B, which can provide noisy state data 308 as input to the teacher model 320 (e.g., following the first stage of the training/update described in connection with FIG. 3A). The simulation 302B is shown as providing stereo RGB image(s) 313 and proprioception data 312 (which may be similar to, and include any of the structure or content of, the proprioception data 212 of FIGS. 2A-2C). The simulation 302B can provide object position data 328 for use in determining an auxiliary loss 334, as described in further detail herein.

The teacher model 320 can be trained/updated, for example, by the model trainer 108 in the first stage described in connection with FIG. 3A. Once trained/updated, the trainable parameters of the teacher model 320 can be held constant during the second stage of the training/update process (e.g., as indicated by the frozen symbol), which is used to train/update the student model 330. As described herein, the teacher model 320 can generate predicted actions for the simulated robot (e.g., the simulated robot 114) in the simulation 302B. As shown, the predicted actions can be used to generate an action loss 332 based at least on the actions 324 generated by the student model 330.

The second stage of the training/update process shown in the diagram 300B can be similar to the second stage of the training/update process described in connection with FIG. 2B. In the example implementation shown, the student model 330 may can include at least one encoder that receives the stereo RGB images 313 as input. The RGB images 313 can be generated according to a rendering process of the 3D simulated environment of the simulation 302B, which may include a ray tracing-based rendering process or any other suitable type of rendering process. In some implementations, model trainer 108 can randomize one or more visual characteristics within the simulations 302B (e.g., across episodes, across multiple simulations, etc.), including material properties (e.g., metallic constants, surface roughness parameters, diffuse tints, etc.), random texture mappings applied to simulated objects, randomized lighting in simulated environments, reflections, or specular highlights, among others, which can be represented in the stereo RGB images 313. The stereo RGB images 313 may be rendered/generated using virtual camera positions that are offset from one another via a predetermined amount, such that depth information can be implicitly derived via processing of each pair of stereo RGB images 313.

The student model 330 is shown as including an encoder (e.g., the encoder 400 described in connection with FIG. 4, etc.), at least one recurrent neural network layer (e.g., an LSTM layer, etc.) and at least one MLP layer. In this example, an output vector of embeddings generated by the encoder can be concatenated with an input vector of proprioception data 312 and provided as input to an LSTM layer with 512 units. Furthering this example, the output of the LSTM layer can concatenated with its input (e.g., via a skip connection) and can be provided as input to the MLP layer(s). In some implementations, three MLP layers may be included, with sizes of [512, 512, 256] units. In some implementations, the output of the LSTM and input to the first set of MLP layers can be concatenated and provided as input to a second set of MLP layers that can generate a predicted object position 346. The second set of MLP layers may have sizes of [512, 256], in some implementations. Further details of the encoder are described in connection with FIG. 4.

Referring briefly to FIG. 4, depicted is a block diagram of an example architecture of a transformer encoder model 400 for stereo image processing to implement dexterous grasping with geometric fabrics according to RGB images, in accordance with some embodiments of the present disclosure. The encoder 400 can receive at least one input token 402, a left image 404, and a right image 406 as input. The encoder 400 can include image models 408A and 408B that may include shared weights. The image models 408A and 408B can respectively produce left tokens 410A and right tokens 410B. The encoder 400 can further include at least one transformer encoder 412 that can process the input token 402, the left tokens 410A, and the right tokens 410B to generate stereo embeddings 414.

The left image 404 and the right image 406 together can form a pair of stereo images. The left image 404 and the right image 406 can depict the same scene from slightly offset viewpoints. In some implementations, the left image 404 and the right image 406 can be obtained concurrently by separate image capture devices (e.g., multiple capture devices 118 such as stereo cameras, dual-lens camera systems, camera arrays, etc.). In some implementations, left image 404 and the right image 406 can be generated concurrently as renderings from a simulated environment (e.g., in the simulation 302B) using a suitable rendering process. The left image 404 and the right image 406 can each comprise RGB color images including pixel intensity values corresponding to red, green, and blue color channels. In some implementations, the left image 404 and the right image 406 can be preprocessed (e.g., resized, cropped, normalized, color-adjusted, among others) prior to provision as input to the transformer encoder model 412.

The image models 408A and 408B can encode the left image 404 and the right image 406, respectively, in a Siamese configuration, where the image models 408A and 408B share identical weights. In some implementations, each of the image models 408A and 408B can be implemented as a pretrained convolutional neural network that includes one or more convolutional layers with intermediate activation functions, pooling layers, or residual connections, among other types of machine-learning layers. The image models 408A and 408B can each generate an intermediate high-dimensional embedding (e.g., a 40960-dimensional feature vector, etc.) based on processing of the left image 404 and the right image 406, respectively.

Each high-dimensional embedding produced by the image models 408A or 408B can be processed through at least one respective MLP layer that can project the embedding vector to a lower-dimensional embedding (e.g., a 16384-dimensional vector, among others). Each lower-dimensional embedding can subsequently be reshaped to generate a predetermined number of embedding tokens (e.g., 128 tokens, etc.), such that each token comprises a respective embedding of fixed dimensions (e.g., 128 dimensions, etc.). Such embedding tokens can be provided as the left tokens 410A and the right tokens 410B, each generated via the image models 408A and 408B, respectively.

The transformer encoder 412 can include one or more transformer layers, with each transformer layer comprising at least one multi-head self-attention unit and one or more feed-forward neural networks. In some implementations, the multi-head self-attention unit can include multiple parallel attention heads configured to perform self-attention, such that each attention head independently computes attention scores and weighted embeddings from input embedding tokens (e.g., the input token 402, the tokens 410A and 410B, etc.). The transformer encoder 412 can further include normalization layers applied before or after the multi-head self-attention modules and the feed-forward neural networks. In some implementations, each transformer layer of the transformer encoder 412 can include skip connections or residual connections.

In some implementations, the transformer encoder 412 can further implement cross-attention operations, such that tokens from the left tokens 410A and the right tokens 410B selectively attend to embedding tokens of the other stereo image or to the input token 402. Such cross-attention operations can be implemented using predefined attention masks that constrain permissible attention paths between embedding tokens, as described herein. The input token 402 can be a learnable token provided as input to the transformer encoder 412 along with tokens corresponding to the left tokens 410A and the right tokens 410B. In some implementations, the input token 402 can attend to all other tokens during a cross-attention operation within the transformer encoder 412.

The transformer encoder 412 can receive embedding tokens produced by the image models 408A and 408B (e.g., the left tokens 410A and the right tokens 410B) along with the input token 402 as input. Upon receiving such embeddings, the transformer encoder 412 can perform one or more multi-head self-attention operations, such that each embedding token updates values based on selectively computed attention scores corresponding to other embedding tokens. In some implementations, embedding tokens from one stereo viewpoint (e.g., left tokens 410A, etc.) can selectively attend to embedding tokens from the other stereo viewpoint (e.g., right tokens 410B, etc.) and/or to the input token 402 to facilitate stereo matching and embedding alignment between the stereo images.

The transformer encoder 412 can process embedding tokens iteratively through multiple transformer layers, updating embedding representations based on such cross-attention interactions. The output tokens from the transformer encoder 412, including output corresponding specifically to the input token 402, can be processed through a multilayer perceptron layer to generate the output stereo embeddings 414. The stereo embeddings 414 can provide learned encoding vectors representative of stereo correspondence information derived from the left image 404 and the right image 406. As described herein, the stereo embeddings 414 can be provided as input to LSTM and/or MLP layers of the student model 330 of FIGS. 3B and 3C.

Referring back to FIG. 3B, the model trainer 108 can iteratively provide the stereo RGB images 313 (e.g., I_{left} and I_{right}, etc.) and proprioception data 312 (e.g., o_{robot}, etc.) as input to the student model 330 on at least a per-timestep basis to generate predicted actions 324 and predicted object position data 346. Concurrently, the model trainer 108 can provide the noisy state data 308 as input to the teacher model 320 to generate predicted teacher actions. The predicted actions 324 and the predict object position 346 can be used to calculate a total loss, which may be a function of the action loss 332 and the auxiliary loss 334. To train/update the student model 330, the model trainer 108 can update the student model 330 according to the total loss. In one example, the total loss value can be represented as [symbol] = [symbol] _{action}+ [symbol] ₐᵤₓ, where [symbol] _{action} corresponds to the action loss 322 and [symbol] ₐᵤₓ corresponds to the auxiliary loss 334. The action loss 322 can be calculated as [symbol] _{action}=D_{KL}(π_{student}∥π_{teacher}), where π_{student} corresponds to the student model 330, π_{teacher} corresponds to the teacher model 320, and D_{KL} corresponds to a KL divergence operation. The auxiliary loss 334 can be calculated as [symbol] ₐᵤₓ=∥\hat{x}_{obj}−x_{obj}∥, where \hat{x}_{obj} corresponds to the predicted object position 346 and x_{obj} corresponds to the object position 328.

Training/updating the student model 330 may include implementing any suitable optimization function and backpropagation function, as described herein. To use the output of the student model 330 to update the state of the simulation 302B, the predicted actions 324 can be provided as input to the geometric fabric 316, as described herein, to generate join PD targets 326 for the simulated robot. The simulation 302B can update the state of the robot according to the joint PD targets 326, resulting in updated noisy state data 308, stereo RGB images 313, and/or proprioception data 312 at the next timestep.

In some implementations, the simulation-update frequency can be different than the action-generation rates (e.g., actions 324 can be generated/provided at 60 Hz, or any other suitable frequency). In such implementations, each generated action 324 can be held constant and effectuated repeatedly across multiple timesteps of the simulation 302B. The model trainer 108 can repeat the generation of actions 324 across multiple iterations of one or more simulations 302B to train/update the student model 230 until a termination condition is satisfied. In some implementations, the termination condition can be satisfied upon completing a preset maximum number of training/update iterations. In some implementations, the termination condition can be satisfied upon determining that performance of the student model 230 exceeds a predetermined success rate. In some implementations, the termination condition can be satisfied upon determining that the total loss has plateaued to a certain degree (e.g., has not changed beyond a certain threshold for a predetermined number of iterations, etc.).

Referring back to FIG. 1, once the model trainer 108 has completed the second stage of the training/update process for the student model 110, the student model 110 can be used to control the physical robot 120 via the geometric fabric controller 106 using color-based images provided from one or more capture devices 118 and sensor signals from the physical robot 120. In such implementations, color-based stereo images can be captured by the capture devices 118 in real-time or near real-time. The color-based stereo images can depict the environment in which physical robot 120 and the physical object 122 are positioned. Sensor data from the physical robot can include proprioception data similar to the proprioception data 212 of FIGS. 2A and 2B, resulting from real-world forces experienced by the physical robot 120. The physical robot 120 can be instructed to manipulate or grasp the physical object 122 in one or more environment according to control instructions generated by the geometric fabric controller 106 based on outputs of the student model 110, as described herein. Further details of the process via which the student model 110 is executed to control the physical robot 120 to manipulate physical objects 122 using color-based images described in connection with FIG. 3C.

Referring to FIG. 3C in the context of the components described in connection with FIGS. 1, 3A, and 3B, depicted is block diagram 300C showing an example data flow for controlling a robot in a physical environment 342 (e.g., the physical robot 120) for implementing dexterous grasping with respect to physical objects (e.g., physical objects 122, etc.), in accordance with some embodiments of the present disclosure. The data processing system 102 can communicate with the robot 242 and capture devices (e.g., the capture devices 118) to receive proprioception data 312 and captured stereo RGB images 333, respectively. In some implementations, one or more capture devices can transmit captured stereo RGB images 333 to the data processing system 102 at predetermined update frequencies or frame rates (e.g., 30 frames-per-second, 60 frames-per-second, or 120 frames-per-second, etc.).

As described herein, the robot 342 (which may be similar to the physical robot 120 of FIG. 1, the robot 242 of FIG. 2C, etc.) can include sensors that can measure proprioception data 312 representing robot-specific internal state information, such as joint angles, actuator positions, joint torques, motor velocities, grip forces applied by end-effectors, temperature readings from actuators, or status indicators of robot components, among others. The proprioception data 312 generated by sensors of the robot 242 can be transmitted to the data processing system 102 via wired or wireless communication channels at predetermined data rates, in some implementations. The data processing system 102 can use the state machine 338 (which may be similar to the state machine 238 of FIG. 2C) to maneuver and/or manipulate objects into one or more target positions and/or configurations. To do so, the data processing system 102 can provide the captured stereo RGB images 333 and the proprioception data 312 as input to the student model 330 (e.g., the student model 110). The data processing system 102 can execute the student model 330, which can process the received inputs to compute predicted position data 336 representing one or more predicted positions of the physical object 122.

The student model 230 can generate predicted object position data 336 for the object(s) and predicted actions 324 for maneuvering/manipulating one or more objects. The actions 324 and the predicted position 336 can be provided as input to the state machine 338, in some implementations. The state machine 338 can be used to determine whether to pass the predicted actions 324 generated by the student model 330 to the geometric fabric 316 or to provide one or more predetermined control actions to the geometric fabric 316. For example, the state machine 238 may cause generation of one or more output actions 240 to release an object (e.g., if the object is positioned at a goal position, etc.), to reinitialize the robot to an initial state or default configuration, or to provide the actions 324 generated by the student model 330 as the output actions 240. The state machine 338 may be defined based at least on configuration settings for a particular application, such that manipulation of the objects in the environment can be controlled to perform one or more tasks such as bin packing or other industrial/manufacturing applications. The output actions 340 can be provided as output to the geometric fabric 316, which can translate the output actions 340 into joint PD targets 326 for the robot in the physical environment 342.

The student model 330 and the geometric fabric 316 can control the robot 342 to perform dexterous object retrieval and placement tasks within a variety of environments, including but not limited to automated manufacturing, assembly-line environments, warehouse management, grocery automation, or food packaging applications, among others. For example, stereo RGB images 333 that capture assembly-line areas, conveyor belts, or component sorting bins can be provided as input to the student model 330, along with proprioception data 312 indicating joint angles or velocities of the robot 342. The student model 330 can be trained/updated using the techniques described herein to predict actions 324 corresponding to suitable grasp orientations and finger configurations for retrieving manufactured items or components designated for downstream assembly, inspection, or consumption by subsequent production stations. The geometric fabric 316 can translate predicted grasp outputs into joint PD targets 326 to control the robot 342 to grasp/manipulate objects to perform various manufacturing tasks/operations.

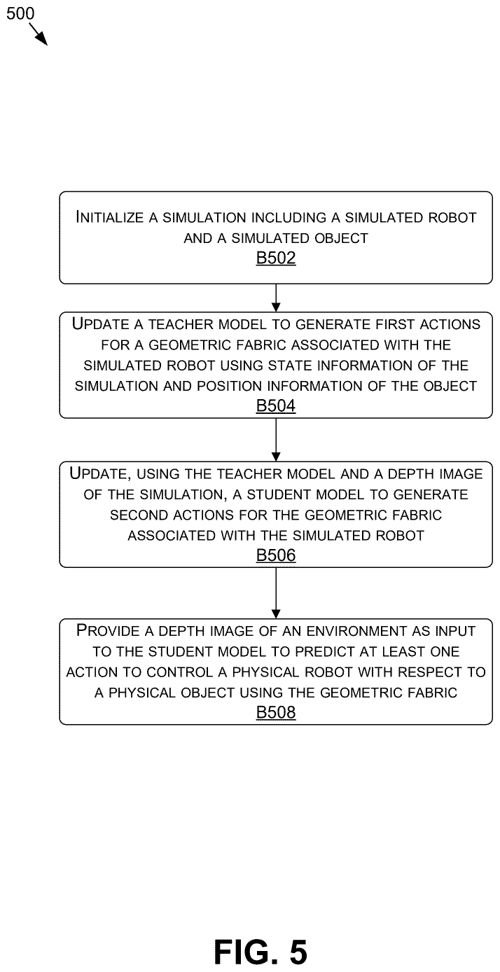

Now referring to FIG. 5, each block of method 500, described herein, includes a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, method 500 is described, by way of example, with respect to FIGS. 1, 2A, 2B, and 2C. However, this method may additionally or alternatively be executed by any one system, or any combination of systems, including, but not limited to, those described herein.

FIG. 5 is a flow diagram showing a method 500 for implementing dexterous grasping with geometric fabrics according to depth images, in accordance with some embodiments of the present disclosure. The method 500, at block B502, can include initializing a simulation (e.g., a simulation 113, 202A, etc.) including a simulated robot (e.g., a simulated robot 114) and a simulated object (e.g., a simulated object 116). Initializing the simulation can involve selecting predetermined physical parameters for the simulated environment, such as gravitational acceleration, friction coefficients, or material stiffness properties, among others. In some implementations, initializing the simulation can include instantiating the simulated robot with specified kinematic parameters, degrees of freedom, and joint configurations, and positioning the simulated object at a designated initial location within a virtual environment (e.g., a virtual table).

Initializing the simulation can include sampling or specifying parameter values to implement domain randomization for the simulation, such as varying the geometric shape of the simulated object, randomizing friction or restitution parameters, or introducing intentional perturbations to simulate external disturbances. Initializing the simulation can also include defining initial sensor configurations for generating simulated sensor readings corresponding to object pose estimates, depth data, or joint position sensor signals, among others. In some implementations, the simulation can be initialized using predefined initialization scripts, stored binary and/or text-based parameter files, configuration files received from external computing systems, or dynamic requests provided by one or more operators of a data processing system executing the simulation, among others.

The method 500, at block B504, can include updating a teacher model (e.g., teacher model 112, teacher model 220, etc.) to generate first actions (e.g., actions 224) for a geometric fabric (e.g., geometric fabric 216) associated with the simulated robot. The teacher model can generate the first actions using state information (e.g., proprioception data 212, etc.) of the simulation and position information (e.g., noisy object pose data 208) of the object. Updating the teacher model can include performing reinforcement learning through interaction with the simulation. In some implementations, updating the teacher model can involve evaluation of one or more reward functions based on outcomes of robotic actions executed in the simulation environment. The reward functions may include terms related to object-to-hand distances, lifting tasks, goal fulfillment, or pose constraints.

The teacher model can be updated by performing asymmetric actor-critic reinforcement learning, where privileged simulation state data inaccessible to the teacher model can be processed by an associated critic model trained in parallel with the teacher model. During training, gradients computed using a loss function incorporating predicted value estimates from the critic model can be propagated through layers of the teacher model, as described in connection with FIG. 2A. In some implementations, updating the teacher model can involve incrementally applying domain randomization and disturbances to the simulation such that the teacher model learns to be robust and adaptive to varied environmental and dynamic conditions.

The method 500, at block B506, can include updating a student model (e.g., student model 110, student model 230, etc.) to generate second actions for the geometric fabric associated with the simulated robot. The student model can be updated using the teacher model and a depth image (e.g., depth images 213) of the simulation. The student model can be updated/trained by performing a distillation process to transfer reinforcement-learned grasping behaviors captured by the teacher model. The student model can be trained/updated to generate second actions based primarily on extracted visual information from provided depth images rather than direct state measurements. In some implementations, updating the student model can include computing a composite loss comprising an action-based loss term measuring divergence from first actions produced by the teacher model and an auxiliary positional loss term quantifying discrepancies between predicted and actual simulated object positions. The student model can include convolutional layers, MLP layers, and/or recurrent neural network layers. The student model can generate actions that control simulation via the geometric fabric. As the state of the simulation changes, the student model can be trained/updated based on the changes in the simulation, thereby iteratively refining the student model based on computed loss gradients associated with observed grasping performance.

The method 500, at block B508, can include providing a depth image (e.g., captured depth image 233) of an environment as input to the student model, for example, following training/updating of the student model. The student model can predict at least one action to control a physical robot (e.g., physical robot 120, robot 242, etc.) with respect to a physical object (e.g., the physical object 122, etc.) using the geometric fabric. Providing the depth image can involve capturing depth-based sensor measurements from the environment including the physical robot and the physical object. In some implementations, the depth images may be derived from data obtained from stereo cameras, structured-light sensors, LiDAR, or time-of-flight imaging devices, among others. In some implementations, providing the depth image as input to the student model can include preprocessing operations such as normalization, image resizing, pixel intensity adjustment, or depth data filtering, or any other technique to modify the depth image to be compatible with the input layer of the student model.

The student model can process the input depth image(s) and input proprioception data from the physical robot to second actions to provide as input to the geometric fabric to control the physical robot. The geometric fabric can translate second actions into joint-level commands (e.g., joint PD targets 226, etc.) that adhere to defined constraints, such as collision avoidance, joint positional limits, or acceleration bounds. The physical robot can be controlled to implement various dexterous grasping and placement tasks with respect to the physical object in any suitable environment, including but not limited to manufacturing environments, warehouse environments, or food preparation or packing environments, among others.

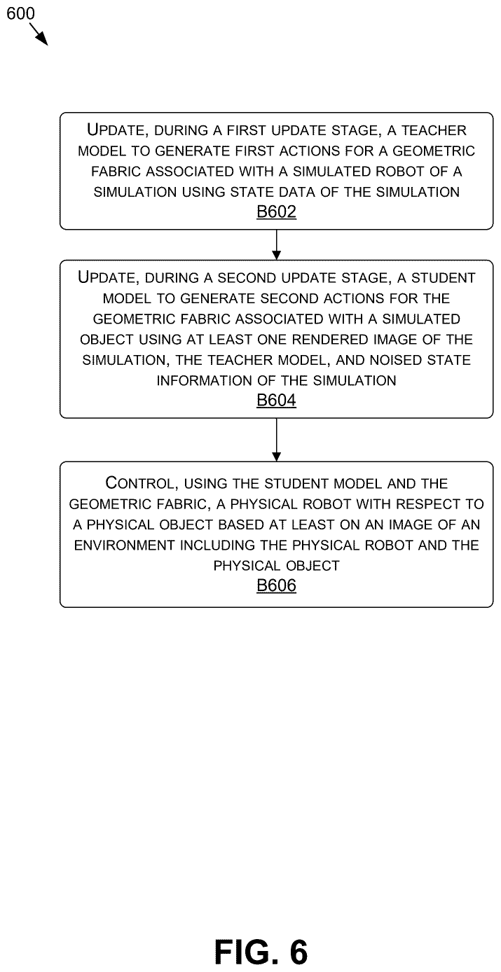

Now referring to FIG. 6, each block of method 600, described herein, includes a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, method 600 is described, by way of example, with respect to FIGS. 1, 3A, 3B, and 3C. However, this method may additionally or alternatively be executed by any one system, or any combination of systems, including, but not limited to, those described herein.

FIG. 6 is a flow diagram showing a method 600 for implementing dexterous grasping with geometric fabrics according to stereo RGB images, in accordance with some embodiments of the present disclosure. The method 600, at block B602, can include updating, during a first update stage (e.g., shown in block diagram 300A), a teacher model (e.g., the teacher model 112, the teacher model 320, etc.) to generate first actions (e.g., actions 224) for a geometric fabric (e.g., geometric fabric controller 106, geometric fabric 316) associated with a simulated robot (e.g., simulated robot 114, etc.) of a simulation (e.g., simulation 113, simulation 302A) using state data (e.g., noisy state data 308, privileged state data 304, etc.) of the simulation. Updating the teacher model can be implemented by processing noisy state data provided as input from the simulation. Such noisy state data can represent imperfect estimates of the positions, velocities, or configurations of a simulated robot or simulated object within the simulation, where the inaccuracy of the estimates is generated via adding one or more randomized noise contributions.

Privileged state data capturing exact positions and velocities of the simulated robot or simulated object may concurrently be provided to a critic model (e.g., the critic model 318) to facilitate calculation of cumulative rewards and estimate value functions for evaluating the teacher model, as described herein. The teacher model can be trained/updated using asymmetric actor-critic reinforcement learning processes, which can include computing and backpropagating loss value(s) based at least on the outputs of the critic model. During training/updating, the simulation can be executed at a predetermined update rate, as described herein, while the teacher model may generate output actions at a second rate.

In some implementations, automatic domain randomization techniques can be implemented within the simulation to vary simulation environments across simulations or simulation episodes. The automatic domain randomization techniques can include varying physical or environmental factors by modifying simulation parameters such as object friction coefficients, damping parameters, robot joint stiffness, actuator damping values, or disturbance forces applied to the robot or objects within the simulated environment. In some implementations, training/updating the teacher model using at least partially randomized simulation parameters can cause the teacher model to learn to generate actions exhibiting robust grasping strategies effective across diverse object geometries, surface characteristics, and environmental conditions.

The method 600, at block B604, can include updating, during a second update stage (e.g., shown in block diagram 300B), a student model (e.g., student model 110, student model 330, etc.) generate second actions for the geometric fabric associated with a simulated object (e.g., simulated object 116) using at least one rendered image (e.g., stereo RGB images 313) of the simulation, the teacher model, and noised state information (e.g., noisy state information 308, etc.) of the simulation. Updating of the student model can include providing stereo RGB images and proprioception data from the simulation as input to the second model to generate predicted actions. The stereo RGB images of the simulation can be rendered from offset simulated camera viewpoints capturing predetermined perspectives, as described herein.

As described in connection with FIGS. 3B and 4, the student model can include one or more encoders, which can include convolutional layers and transformer-based cross-attention units that can generate stereo image embeddings. The cross-attention unit(s) can implement one or more cross-attention masks that can cause the encoder to selectively attend to the other of the stereo RGB images, such that the student model can be trained/updated to infer correspondence and depth relationships from the stereo RGB images. In some implementations, the second training/update stage can implement a two-component loss function including an action loss and an auxiliary loss term. The action loss can quantify differences between the actions generated by the student model and corresponding actions generated by the trained/updated teacher model. The auxiliary loss term can measure differences between student-predicted simulated object positions and actual object positions tracked exactly within the simulation. Updates to the student model parameters during the second update stage can be performed according to gradient computations and backpropagation with respect to the combined loss value, as described herein.

The method 600, at block B606, can include controlling, using the student model and the geometric fabric, a physical robot (e.g., the physical robot 120, the robot 342, etc.) with respect to a physical object (e.g., the physical object 122) based at least on an image (e.g., the captured RGB images 333, etc.) of an environment including the physical robot and the physical object. To control the physical robot within an actual environment, stereo RGB images capturing positions and orientations of the physical object, robot, and surrounding environment can be provided as inputs to the trained student model. In some implementations, two or more camera or image capture systems (e.g., stereo capture devices 118) can concurrently capture offset visual perspectives of the environment as the stereo RGB images. Proprioception data captured by sensors of the physical robot can be provided as input to the student model with the stereo RGB images. The student model can generate output robot actions that can be provided as input to the geometric fabric, as described herein.

Control instructions for the robot may be generated through translating the actions generated by the student model using the geometric fabric. To do so, the geometric fabric can convert the predicted actions into joint PD targets (e.g., joint PD targets 326) that enforce collision avoidance, enforce joint limits, and direct robot configurations. The output action targets generated through the geometric fabric can guide the physical robot joints via joint actuator commands to perform grasping/manipulation movements with respect to the physical object. In some implementations, a state machine can monitor predicted object positions generated by the student model to determine suitable grasp transitions, continued grasp closures, or object-release decisions. Such robot grasping actions can be used to implement accurate, reactive, and robust grasping behavior adaptable across diverse object shapes, textures, and environmental conditions for various industrial or manufacturing use cases.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 7A is an example of sensor locations having corresponding fields of view or sensory fields for an autonomous or semi-autonomous vehicle 700a, an autonomous mobile robot (AMR) 700b, and a humanoid robot 700c, in accordance with some embodiments of the present disclosure. Although three types of machines 700 are illustrated, this is not intended to be limiting, and the machine(s) 700 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 700a, AMR 700b, humanoid robot 700c, and/or other machine types may be referred to herein collectively as machine 700, in some instances.

With respect to vehicles 700A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 700 may be capable of functionality in accordance with one or more of Level 3-Level 5 of the autonomous driving levels. The machine 700 may be capable of functionality in accordance with one or more of Level 1-Level 5 of the autonomous driving levels. For example, the machine 700 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 700 or other machine, such as being fully autonomous, being highly autonomous, being conditionally autonomous, being partially autonomous, providing assistive autonomy, being semi-autonomous, being primarily autonomous, or other designation.

With respect to FIG. 7A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 768D, a 180 degree field of view of a wide-view camera 770, a 360 degree sensory field of a LiDAR sensor 764, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 700a, AMR 700b, and/or humanoid robot 700c, etc. For example, with respect to the vehicle 700a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 700b and/or humanoid robot 700c, the shape, size, purpose, implementation, model, etc. may dictate the number and types of sensors used.

As illustrated in FIG. 1A, the autonomous or semi-autonomous vehicle 700A, the AMR 700B, and the humanoid robot 700C may include different sensor types, number, and locations. For a non-limiting example, the vehicle 700A may include twelve cameras 764, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 764 may use, in embodiments, a gigabit multimedia serial link (GMSL) interface—such as GMSL2—as input/output (I/O).

In some embodiments, although not illustrated in FIG. 7A, the vehicle 700A may include an in-cabin occupant and/or driver monitoring system, that may include various different sensors. For example, the in-cabin sensors may include various cameras 768, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 768, the internal camera(s) 768 may, in embodiments, use a GMSL (such as GMSL2) interface for I/O.

As another non-limiting example, the vehicle 700A may further include nine RADAR sensors 760. For example, the vehicle 700A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 760 may use, in embodiments, an Ethernet interface as I/O.

The vehicle(s) 700A may further include, as a non-limiting example, twelve ultrasonic sensors 762. As illustrated in FIG. 7A, the ultrasonic sensors may be positioned along the front and rear bumpers of the vehicle 700A, and along the side of the vehicle 700A, and may be used to detect objects (static and dynamic) in close proximity to the vehicle 700A. In some embodiments, the ultrasonic sensor(s) 762 may use a DS13 interface as I/O.

The vehicle(s) 700A may further include, as a non-limiting example, a LiDAR sensor 764, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 764 may include a 360 degree horizontal FOV or sensory field (such as in a spinning LiDAR sensor) and a 90 degree vertical FOV or sensory field. In some embodiment, the LiDAR sensor(s) 764 may use an Ethernet interface as I/O.

The autonomous mobile robot (AMR) 700B may include, as a non-limiting example, three LiDAR sensors 764. For example, the top-most illustrated LiDAR sensor 764 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 700B may further include, as a non-limiting embodiment, eight cameras 768, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 700B may further include a charging port, charging port contacts, a status indicator light, one or more (e.g., four) RGB LEDs, one or more IMU sensors 766, a magnetometer, and a barometer. The AMR 700B is capable of high-precision time synchronization between sensors using hardware time stamping, and PTP over Ethernet with less than 10 microseconds for sensor acquisition time. The AMR 700B provides simultaneous camera capture across all cameras 768 within 100 microseconds from a single hardware trigger, in embodiments, and can write to disk at 4 GB/second for sensor capture to bag writing (e.g., writing to ROSbags for the robot operation system (ROS)). As such, the AMR 700B is capable of running the ROS (such as NVIDIA's Isaac ROS), can be teleoperated (as described herein), can map an environment, and can navigate within an environment using visual cameras 768, LiDARs 764, and/or other sensor types or modalities.

The humanoid robot 700C may include, as a non-limiting example, one LiDAR sensor 764. For example, the LiDAR sensor 764 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 700C may further include, as a non-limiting embodiment, four cameras 768, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 700C may further include, as a non-limiting embodiment, four ultrasonic sensors 762, such as a left arm ultrasonic sensor, a right arm ultrasonic sensor, a left leg ultrasonic sensor, and right leg ultrasonic sensor.

The humanoid robot 700C may further include any number of actuators-such as to allow control and maneuverability of joints. For example, the humanoid robot 700C may include actuators that allow for various degrees of freedom (DoF) depending on the design. In a non-limiting embodiment, the humanoid robot 700C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 700C may include position and orientation sensors, such as encoders, gyroscopes, and the like, to determine the position of the robot 700C in space, allowing for location determination and movement tracking. The humanoid robot 700C may include force and pressure sensors, in embodiments, to detect environment interactions, allowing the robot 700C to grasp objects with the right force and to avoid obstacles along the way. The perception sensors (e.g., cameras, LiDARs, RADARs, ultrasonic, SONAR, etc.) may be used along with tactile sensors to allow the robot 700C to perceive objects, shapes, and textures, and to understand when touch is initiated and stopped (along with force sensors that regulate the force used during touch). As a non-limiting example, the humanoid robot 700C may have a height of about 1-2 meters (e.g., 1.7 meters or 5′6″), a weight of 50-70 kg, be capable of moving at a speed of 8 or more km/h, and be able to carry payloads anywhere from 20-100 kg, depending on the design and requirements of the system.

The humanoid robot 700C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 700C may use onboard sensors, microphones, and speakers to understanding speech, audio and visual cues, etc., while also being able to communicate back to the environment.

With reference to cameras 768 of the machine(s) 700, the camera types for the cameras 768 may include, but are not limited to, digital cameras that may be adapted for use with the components and/or systems of the machine 700. For a vehicle 700a implementation, the camera(s) 768 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 768B that may be used to perceive objects coming into view from the periphery (e.g., pedestrians, warehouse vehicles, other robots, crossing traffic, or bicycles). In addition, any number of long-range camera(s) 768E (e.g., a long-view stereo camera pair) may be used for depth-based object detection, especially for objects for which a neural network has not yet been trained. The long-range camera(s) 768E may also be used for object detection and classification, as well as basic object tracking.

Any number of stereo cameras 768A may also be included in a front-facing and/or other (e.g., rear-facing) configuration. In at least one embodiment, one or more of stereo camera(s) 768A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 700 environment, including a distance estimate for points in the image (e.g., a disparity or depth image). An alternative stereo camera(s) 768A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 700 (e.g., side-view cameras) may be used, for example, for surround view, providing information used to create and update the occupancy grid, as well as to generate side impact collision warnings and/or to indicate to an AMR 700B or humanoid robot 700C, for example, that there are objects, features, and/or persons present to the side. For example, surround camera(s) 768D may be positioned on the machine 700. The surround camera(s) 768D may include wide-view camera(s) 768B, fisheye camera(s), 360 degree camera(s), and/or the like. For example, four fisheye cameras may be positioned on the machine's 700 front, rear, and sides. In an alternative arrangement, the machine 700 may use three surround camera(s) 768D (e.g., left, right, and rear), and may leverage one or more other camera(s) (e.g., a forward-facing camera) as a fourth surround view camera.

Cameras 768 with a field of view that include portions of the environment to the rear of the machine 700 (e.g., rear-view cameras) may be used for gaining an understanding of objects, features, persons, and/or other information to the rear of the machine 700, such as for park assistance, surround view, rear collision warnings, planning, control, and navigation determinations, and/or creating and updating an occupancy grid, BEV image representing the environment, height map, etc. A wide variety of cameras 768 may be used including, but not limited to, cameras 768 that are also suitable as a front-facing camera(s) (e.g., long-range and/or mid-range camera(s) 768E, stereo camera(s) 768A), infrared camera(s) 768C, etc.), rear-facing camera(s), side-facing camera(s), downward facing camera(s), upward facing camera(s), and/or the like, as described herein.

Similarly, for LiDAR sensors 764, RADAR sensors 760, ultrasonic sensors 762, and/or other sensor modalities or types, the location and placement of the sensors, and their corresponding fields of view or sensory fields may be determined based on the use case, implementation, or design of the particular machine 700.

For example, the machine(s) 700 include RADAR sensor(s) 760 that may be used by the machine 700 for long-range object detection, even in darkness and/or severe weather conditions. RADAR functional safety levels may be ASIL B, in embodiments. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning, by robots for detecting dynamic objects in various environments-such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 700 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 760 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 700 (e.g., vehicle, robot, etc.). As such, short-range RADAR systems may be used in an ADAS system for blind spot detection and/or lane change assist.

The machine 700 may further include ultrasonic sensor(s) 762. The ultrasonic sensor(s) 762, which may be positioned at the front, back, and/or the sides of the machine 700, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 700. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B, as an example.

The machine 700 may include LiDAR sensor(s) 764. The LiDAR sensor(s) 764 may be used for object and feature detection, pedestrian and other robot detection, emergency braking, collision avoidance, simultaneous localization and mapping (SLAM), free-space detection, and/or other functions. The LiDAR sensor(s) 764 may be functional safety level ASIL B, in embodiments. In some examples, the machine 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700 m, with an accuracy of 2 cm-3 cm, and with support for a 700 Mbps Ethernet connection, for example. In some examples, one or more non-protruding LiDAR sensors 764 may be used. In such examples, the LiDAR sensor(s) 764 may be implemented as a small device that may be embedded into the front, rear, sides, top, and/or corners of the machine 700. The LiDAR sensor(s) 764, in such examples, may provide up to a 120-degree horizontal and 35-degree vertical field-of-view, with a 200 m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 700. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

FIG. 7B is an illustration of sensor and component locations of an example autonomous or semi-autonomous vehicle 700A (alternatively referred to herein as “vehicle 700,” “ego-vehicle 700,” “ego-machine 700,” or “machine 700,”), in accordance with some embodiments of the present disclosure. Although the vehicle 700A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 7C is a block diagram of an example system architecture for a machine 700, such as autonomous or semi-autonomous vehicle 700A, autonomous mobile robot (AMR) 700B, humanoid robot 700C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

Each of the components, features, and systems of the machine 700 in FIG. 7C are illustrated as being connected via bus 702 (alternatively referred to as a “machine communications network 702,” or just “communications network 702”). The bus 702 may include a Controller Area Network (CAN) data interface (alternatively referred to herein as a “CAN bus”). A CAN may be a network inside the machine 700 used to aid in control of various features and functionality of the machine 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 702 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the machine 700, and two or more busses 702 may communicate with the same components. In some examples, each SoC 704, each controller 736, and/or each computer or compute engine within the machine 700 may have access to the same input data (e.g., inputs from sensors of the machine 700), and may be connected to a common bus, such as a CAN bus.

The machine 700 may include components such as a chassis, a vehicle body, wheels (e.g., 2, 4, 6, 8, 18, etc.), tires, axles, batteries, side-view mirrors, and/or other components of a vehicle or machine. The machine 700 may include a propulsion system 750, such as an internal combustion engine, hybrid electric power plant, an all-electric engine, a hydrogen-fueled engine, and/or another propulsion system type. The propulsion system 750 may be connected to a drive train of the machine 700, which may include a transmission, to enable the propulsion of the machine 700. The propulsion system 750 may be controlled in response to receiving signals from the throttle/accelerator 752.

A steering system 754, which may include a steering wheel and/or other steering device (e.g., remote steering and/or local steering), may be used to steer the machine 700 (e.g., along a desired path or route) when the propulsion system 750 is operating (e.g., when the vehicle is in motion). The steering system 754 may receive signals from a steering actuator 756. In some embodiments, a steering wheel or other steering mechanism may not be included, such as for a machine 700 capable of full automation (e.g., Level 5) functionality.

The brake sensor system 746 may be used to operate the vehicle brakes in response to receiving signals from the brake actuators 748 and/or brake sensors.

The machine 700 may include one or more controller(s) 736, such as those described herein with respect to FIG. 7A. The controller(s) 736 may be used for a variety of functions, and may be coupled to any of the various other components and systems of the machine 700. For example, the controllers 736 may be used for control of the machine 700, artificial intelligence executing on the machine 700, infotainment for the machine 700, and/or the like. For example, one controller 736 may be used for some or all of the functionality, or different controllers 736 may be used for different functionalities—e.g., to ensure availability and a safety separation between various controllers for different tasks. For example, the controller(s) 736 may use plans computed by the system—e.g., paths or trajectories for vehicles 700A or AMRs 700B, or movements, components trajectories, movement locations or displacements, etc, for joints or components (e.g., of manipulators, end effectors, limbs, hands, fingers, legs, feet, etc.), of a humanoid robot 700C—to control the machine(s) 700 in the environment. In some instances, the controller(s) 736 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 700C, for example, the controller(s) 736 may act as the brain, responsible for analyzing sensor data, making decisions, and sending commands to the actuators. The controller(s) 736 may include a low-level controller that handles basic motor control, ensuring accurate and precise movements of individual joints and actuators. The controller(s) 736 may include a high-level controller to coordinate multiple actuators and sensors, planning complex motions and adapting to changing environments.

The controller(s) 736 may include an artificial intelligence controller, in embodiments, that may use AI algorithms (e.g., DNNs, MLMs, etc.) to learn, make decisions, and autonomously perform tasks for the machine 700. In some embodiments, the controller(s) 736 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 736 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 736, which may include one or more systems on chip (SoCs) 704 (FIGS. 7C and 7D), CPUs, GPU(s), accelerator(s), etc., may provide signals (e.g., representative of commands or messages) to one or more components and/or systems of the machine 700. Although the controller(s) 736 is listed separately from the SoC(s) 704, this is not intended to be limiting, and in some embodiments one or more components of the SoC(s) 704 may perform the operations of the controller(s) 736. For example, the controller(s) may send signals to operate the machine brakes via one or more brake actuators 748, to operate the steering system 754 via one or more steering actuators 756, to operate the propulsion system 750 via one or more throttle/accelerators 752, etc. The controller(s) 736 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 700. The controller(s) 736 may include a first controller 736 for autonomous control and navigation functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 736 may handle two or more of the above functionalities, two or more controllers 736 may handle a single functionality, and/or any combination thereof.

The controller(s) 736 may provide the signals for controlling one or more components and/or systems of the machine 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, camera(s) 768 (e.g., stereo camera(s) 768A, wide-view camera(s) 768B (e.g., fisheye cameras), infrared camera(s) 768C, surround camera(s) 768D (e.g., 360 degree cameras), long-range and/or mid-range camera(s) 768E, and/or other camera types), speed sensor(s) 744 (e.g., for measuring the speed of the machine 700), vibration sensor(s) 742, steering sensor(s) 740, brake sensor(s) (e.g., as part of the brake sensor system 746), actuators, and/or other sensor types.

One or more of the controller(s) 736 may receive inputs (e.g., represented by input data) from an instrument cluster 732 of the machine 700 and provide outputs (e.g., represented by output data, display data, etc.) via a human-machine interface (HMI) display 734 (e.g., screen, heads-up display, mirror display, facial display, robotic display, etc.), an audible annunciator, a loudspeaker, a speaker, and/or via other components of the machine 700. The outputs may include information such as machine velocity, speed, time, map data corresponding to a map(s) 722 of FIG. 7C (e.g., from a navigation map, a Standard Definition (SD) map, a High Definition (“HD”) map, etc.), location data (e.g., the machine's 700 location, such as on a map 722), direction, location of other vehicles (e.g., an occupancy map, height map, bird's eye view (BEV) image, grid, etc.), information about objects and status of objects as perceived by the system, system status information, etc. For example, the HMI display(s) 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 700 may include one or more systems on a chip (SoCs) 704 (described in more detail in FIG. 7D). The SoC(s) 704 may include CPU(s) 706, GPU(s) 708, processor(s) 710, cache(s) 712, accelerator(s) 714, data store(s) 716, and/or other components and features. The SoC(s) 704 may be used to process and provide data for various operations, such as navigation, planning, reasoning, inference, perception, control, and/or actuation operations of the machine 700 in a variety of platforms and systems. For example, the SoC(s) 704 may process live perception data (e.g., from camera, LiDAR, RADAR, ultrasonic, etc.) in addition to map data corresponding to one or more maps 722 (e.g., HD map, SD map, navigational map, occupancy map, etc.) in order to make or aid in performing various operations of the machine 700. Where a map and/or AI is used, map and/or AI (e.g., model parameter updates, fine-tuning, etc.) refreshes and/or updates via a network interface 724 from one or more servers (e.g., server(s) 778 of FIG. 7E)—such as one or more servers of a cloud-based data center.

Although an SoC(s) 704 is illustrated throughout FIGS. 7A-7E, additional or alternative components and/or architectures may be used-such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 700, use of the machine 700, model of the machine 700, and required capabilities of the machine 700, one or more SoCs 704 and/or alternative architectures and/or components may be used to satisfy the particular implementation.

The machine 700 may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The machine 700 may include a GPU(s) 720 (e.g., discrete GPU(s), or dGPU(s)), that may be coupled to the SoC(s) 704 via a high-speed interconnect (e.g., NVIDIA's NVLink). The GPU(s) 720 may provide additional artificial intelligence functionality, such as by executing redundant and/or different neural networks, and may be used to train and/or update neural networks based on input (e.g., sensor data) from sensors of the machine 700.

The machine 700 may further include the network interface 724 which may include one or more wireless antennas 726 and/or modems (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 700 information about vehicles in proximity to the machine 700 (e.g., vehicles in front of, on the side of, and/or behind the machine 700). This functionality may be part of a cooperative adaptive cruise control functionality of the machine 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The machine 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The machine 700 may further include IMU sensor(s) 766. The IMU sensor(s) 766 may be located at a center of the rear axle of the machine 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the machine 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include one or more microphone 796 placed in and/or around the machine 700. The microphone(s) 796 may be used for emergency vehicle detection and identification, among other things.

The machine 700 may further include vibration sensor(s) 742. The vibration sensor(s) 742 may measure vibrations of components of the machine, such as the arms or legs of a humanoid robot 700C, or the axle(s) of a vehicle 700A or AMR 700B. For example, changes in vibrations may indicate a change in road, walking, or traversable surfaces. In another example, when two or more vibration sensors 742 are used, the differences between the vibrations may be used to determine friction or slippage of the surface (e.g., when the difference in vibration is between a power-driven axle and a freely rotating axle).

The machine 700 may include an ADAS system 738—such as when the machine 700 is a vehicle 700A. The ADAS system 738 may include a dedicated SoC(s), in some examples. The ADAS system 738 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 700 may further include the infotainment SoC 730 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the machine 700. In some examples, the infotainment SoC 730 may be coupled to a supervisory MCU such that the GPU of the infotainment system may perform some self-driving functions in the event that the primary controller(s) 736 (e.g., the primary and/or backup computers of the machine 700) fail. In such an example, the infotainment SoC 730 may put the machine 700 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models-such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 700—whether a vehicle 700A, AMR 700B, humanoid robot 700C, and/or other type of machine—may include a locally stored language model(s) and/or communicate to a remotely hosted language model (e.g., via one or more APIs) to provide more detailed and in-depth communication features to the users of the machine(s) 700.

In some examples, an infotainment SoC 730, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In some embodiments, an in-cabin monitoring camera sensor may be monitored using one or more neural networks running on another or dedicated SoC-such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 700.

The machine 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a block diagram of an example architecture of a computing system (a subset of the system described with respect to FIG. 7C), in accordance with at least some embodiments of the present disclosure. Although illustrated as an SoC(s) 704, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 704 may be an end-to-end platform with a flexible architecture that spans automation levels 2-5, or the SoC(s) 704 may be specifically designed for a specific automation level (e.g., a first SoC 704 for level 2 to level 2++, a second SoC 704 for level 3, a third SoC 704 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 2-5 autonomous vehicles as well as for safe planning, navigation, and control of AMRs 700B, humanoid robots 700C, and/or other robot or machine types.

In some embodiments, such as where the SoC(s) 704 include a GPU 708 with 2000 or more cores (e.g., 2048 cores), 60 or more tensor cores (e.g., 64 tensor cores), and a GPU max frequency of over 1 GHz (e.g., 1.3 GHZ), a CPU 706 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 709 (e.g., 2 DLAs/XNNs/NNAs/NPUs 709), and a vision accelerator-such as a programmable vision accelerator (PVA) 707, a single SoC 704) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 704 include a GPU 708 with 1700 or more cores (e.g., 1792 cores), 50 or more tensor cores (e.g., 56 tensor cores), and a GPU max frequency of over 900 MH2 (e.g., 930 MHz), a CPU 706 including 8 or more cores (e.g., 8 cores), with 64 bits, 2 MB L2 and 4 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 709 (e.g., 2 DLAs/XNNs/NNAs/NPUs 709), and a vision accelerator-such as a programmable vision accelerator (PVA) 707, a single SoC 704) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 704 include a GPU 708 with 1000 or more cores (e.g., 1024 cores), 28 or more tensor cores (e.g., 32 tensor cores), and a GPU max frequency of over 900 MHz (e.g., 1173 MHz), a CPU 706 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 709 (e.g., 1 DLA/XNN/NNA/NPU 709), and a vision accelerator-such as a programmable vision accelerator (PVA) 707, a single SoC 704) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 704 include a GPU 708 with 1000 or more cores (e.g., 1024 cores), 28 or more tensor cores (e.g., 32 tensor cores), and a GPU max frequency of over 900 MHz (e.g., 1020 MHz), a CPU 706 including 6 or more cores (e.g., 6 cores), with 64 bits, 1.5 MB L2 and 4 MB L3 cache memory, and a max frequency of 1.5 or more GHz (e.g., 1.7 GHZ), a single SoC 704) may be capable of 67 tera operations per second (TOPS) of AI performance. For example, NVIDIA's Jetson Orin Nano 8 GB SoC satisfies these criteria, and achieves this performance.

The SoC(s) 704 may include one or more CPUs 706. The CPU(s) 706 may include a CPU cluster or CPU complex (alternatively referred to herein as a “CCPLEX”), in embodiments. The CPU(s) 706 may include multiple cores and/or (e.g., L2, L3) caches. For example, in some embodiments, the CPU(s) 706 may include twelve cores in a coherent multi-processor configuration. In some embodiments, the CPU(s) 706 may include four dual-core clusters where each cluster has a dedicated L2 cache (e.g., a 3 MB L2 cache). The CPU(s) 706 (e.g., the CCPLEX) may be configured to support simultaneous cluster operation enabling any combination of the clusters of the CPU(s) 706 to be active at any given time.

The SoC(s) 704 may include any type and number of GPUs 708. For example, an integrated GPU(s) (alternatively referred to herein as an “iGPU(s)”) may be used in some embodiments. The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive, robotics, and/or other embedded use cases. For example, the GPU(s) 708 may be fabricated on a Fin field-effect transistor (FinFET). However, this is not intended to be limiting and the GPU(s) 708 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

The SoC(s) 704 may include any number of cache(s) 712, including those described herein. For example, the cache(s) 712 may include L0 caches, L1 caches, L2 caches, L3 caches (e.g., that are available to both the CPU(s) 706 and the GPU(s) 708 (e.g., that is connected both the CPU(s) 706 and the GPU(s) 708)), etc. The cache(s) 712 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 704 may include one or more arithmetic logic units (ALUs) 765 which may be leveraged in performing processing with respect to any of the variety of tasks or operations of the machine 700—such as computer vision, machine learning or deep learning processing, world model management, etc. In addition, the SoC(s) 704 may include a floating point unit(s) (FPU(s)) 767—or other math coprocessor or numeric coprocessor types—for performing mathematical operations within the system. For example, the SoC(s) 104 may include one or more FPUs 767 integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory 715 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 714 (e.g., the hardware acceleration cluster) may include a deep learning accelerator(s) (DLA) 709 (alternatively referred to herein as “a deep learning accelerator cluster (XNN) 709,” “neural network accelerator (NNA) 709,” or “neural processing unit (NPU) 709”). The DLA(s) 709 may include one or more Tensor processing units (TPUs) 741 that may be configured to provide an additional, e.g., ten trillion operations per second for deep learning applications and inferencing. The TPUs 741 may be accelerators configured to, and optimized for, performing image processing functions (e.g., for CNNs, RCNNs, DNNs, etc.). The DLA(s) 709 may further be optimized for a specific set of neural network types and floating point operations, as well as inferencing. The design of the DLA(s) may provide more performance per millimeter than a general-purpose GPU, and vastly exceeds the performance of a CPU. The TPU(s) 741 may perform several functions, including a single-instance convolution function, supporting, for example, INT8, INT16, and FP16 data types for both features and weights, as well as post-processor functions. Although the TPU(s) 741 are described as being included as part of the DLA(s) 709, this is not intended to be limiting, and the TPU(s) 741 may be included in additional or alternative accelerator(s) 714 and/or other components, and/or may be included as a discrete processing component(s).

The DLA(s) 709 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 709 may perform any function of the GPU(s) 708, and by using an inference accelerator, for example, a designer may target either the DLA(s) 709 or the GPU(s) 708 for any function. For example, the designer may focus processing of DNNs and floating point operations on the DLA(s) 709 and leave other functions to the GPU(s) 708 and/or other accelerator(s) 714. The DLA(s) 709 may be used to run any type of network to enhance control and safety, including for example, a neural network that outputs a measure of confidence for each object detection.

The accelerator(s) 714 (e.g., the hardware acceleration cluster) may include a programmable vision accelerator(s) (PVA) 707, which may alternatively be referred to herein as a computer vision accelerator or generally a vision accelerator. The PVA(s) 707 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 707 may provide a balance between performance and flexibility. For example, each PVA(s) 707 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 707 may be optimized for the tasks of image processing and computer vision algorithm acceleration. For example, the PVA(s) 707 provides excellent performance with extremely low power consumption, and can be used asynchronously and concurrently with the CPU(s) 706, GPU(s) 708, and/or other accelerators in the system (e.g., vehicle, robot, etc.) as part of a heterogeneous compute pipeline.

The PVA(s) 707 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 743 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 706 (e.g., ARM Cortex-R5 processor), facilitating data exchange with the CPU(s) 706 and other system-level components. The VPU I-cache may supply instruction data to the VPU(s) when requested, may request missing instruction data from system memory, and/or may maintain temporary instruction storage for the VPU. For each VPU task, the CPU(s) 706 may configures the DMA system, optionally prefetch the VPU program into VPU I-cache, and/or kick off each VPU-DMA pair to process a task. The PVA(s) 707 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 707 to access the system memory independently of the CPU(s) 706. The DMA may support any number of features used to provide optimization to the PVA(s) 707 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 707 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 707, and may include one or more vector processing units (VPUs), one or more pixel processing engines (PPEs) which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 707 may be configured to employ data parallelism. For example, in some embodiments, the plurality of vector processors included in a single PVA(s) 707 may execute the same computer vision algorithm, but on different regions of an image. In other examples, the vector processors included in a particular PVA(s) 707 may simultaneously execute different computer vision algorithms, on the same image, or even execute different algorithms on sequential images or portions of an image. Among other things, any number of PVAs 707 may be included in the hardware acceleration cluster and any number of vector processors may be included in each of the PVAs. In addition, the PVA(s) 707 may include additional error correcting code (ECC) memory, to enhance overall system safety.

The accelerator(s) 714 (e.g., the hardware accelerator cluster) have a wide array of uses for autonomous and semi-autonomous machine control. The PVA(s) 707 may be a programmable vision accelerator that may be used for key processing stages in perception, robotics understanding and reasoning, ADAS, semi-autonomous, and autonomous vehicles, etc. The PVA's 707 capabilities are a good match for algorithmic domains needing predictable processing, at low power and low latency. In other words, the PVA(s) 707 performs well on semi-dense or dense regular computation, even on small data sets, which need predictable run-times with low latency and low power. Thus, in the context of platforms for autonomous vehicles and robotics, the PVAs 707 are designed to run classic computer vision algorithms, as they are efficient at object detection and operating on integer math.

For example, according to one embodiment of the technology, the PVA 707 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 707 may perform computer stereo vision function on inputs from two monocular cameras.

In some examples, the PVA(s) 707 may be used to perform dense optical flow. According to process raw RADAR data (e.g., using a 4D Fast Fourier Transform) to provide Processed RADAR. In other examples, the PVA(s) 707 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 707, this is not intended to be limiting. In some embodiments, these components may be included in alternative or additional processing components and/or accelerator(s) 714, and/or may be included as discrete components of the SoC(s) 704 and/or other computing system architecture(s).

In some examples, the SoC(s) 704 may include a real-time ray-tracing hardware accelerator (RTA) 751 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 700 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 751 and/or a ray-tracing optimized GPU 706—such as NVIDIA's RTX GPU.

The accelerator(s) 714 (e.g., in the hardware acceleration cluster) may include one or more optical flow accelerators (OFAs) 711. For example, the OFA(s) 711 may be used for computing optical flow and stereo disparity between frames of sensor data (e.g., images). Optical flow may be accelerated on the OFA(s) 711 for uses such as object detection and tracking, and/or for stereo depth estimation where used for computing stereo disparity between stereo image frames (e.g., two or more frames captured using two or more image sensors with at least partially overlapping fields of view).

The SoC(s) 704 may include one or more camera serial interfaces (CSIs) 723. For example, the CSI(s) 723 may include a mobile industry processor interface (MIPI) camera serial interface (CSI) for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role. For example, the CSI 723 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 714 (e.g., the hardware acceleration cluster) may include a computer vision network on-chip (CVNOC) 763 and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by the PVA 707, OFA 711, DLA 709, and/or other accelerator(s) 714. Each pair of memory blocks may include an advanced peripheral bus (APB) interface, configuration circuitry, a controller, and a multiplexer. Any type of memory 715 may be used. The PVA 707, OFA 711, DLA 709, and/or other accelerator(s) 714 may access the memory via a backbone that provides the accelerator(s) 714 with high-speed access to memory. The backbone may include a computer vision network on-chip that interconnects the accelerator(s) 714 to the memory (e.g., using the APB).

The CVNOC 763 may include an interface that determines, before transmission of any control signal/address/data, that the accelerator(s) 714 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 704 may include data store(s) 716 and/or memory 715. The data store(s) 716 may be on-chip memory 715 of the SoC(s) 704, which may store neural networks and/or other algorithms to be executed on the CPU(s) 706, the GPU(s) 708, and/or one or more of the accelerator(s) 714. In some examples, the data store(s) 716 may be large enough in capacity to store multiple instances of neural networks for redundancy and safety. The data store(s) 712 may comprise L2 and/or L3 cache(s) 712, for example. The memory (ies) 715 may include SRAM, LPDDR5, and/or other memory types. For example, the memory (ies) 715 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 716 may include reference to the memory associated with the PVA 707, OFA 711, DLA 709, and/or other accelerator(s) 714, as described herein.

The data store(s) 116 may include various storage types, such as eMMC, NVMe, etc. For example, the SoC(s) 704 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 716 and/or other storage may be accessed via, e.g., NVMe, using PCI Express (PCIe), RDMA, TCP, and/or other protocols.

The SoC(s) 704 may include one or more processor(s) 710 (e.g., embedded processors). The processor(s) 710 may include a boot and power management processor (BPMP) 753, that may be a dedicated processor and subsystem to handle boot power and management functions and related security enforcement. The BPMP 753 may be a part of the SoC(s) 704 boot sequence and may provide runtime power management services. The BPMP 753 may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, accelerator(s) 714, and/or other components. If temperatures are determined to exceed a threshold, BPMP 753 may enter a temperature fault routine and put the SoC(s) 704 into a lower power state and/or put the machine 700 into a chauffeur to safe stop mode (e.g., bring the machine 700 to a safe stop).

The processor(s) 710 may further include a set of embedded processors that may serve as an audio processing engine (APE) 755. The APE 755 may be an audio subsystem that enables full hardware support for multi-channel audio over multiple interfaces, and a broad and flexible range of audio I/O interfaces. In some examples, the APE 755 is a dedicated processor core with a digital signal processor with dedicated RAM.

The processor(s) 710 may further include an always on processor engine (AOPE) 757 that may provide necessary hardware features to support low power sensor management and wake use cases. The AOPE 757 may include a processor core, a tightly coupled RAM, supporting peripherals (e.g., timers and interrupt controllers), various I/O controller peripherals, and routing logic.

The processor(s) 710 may further include a safety processor(s) 713 (alternatively referred to as “safety island 713”), which may include a safety cluster engine that includes a dedicated processor or processor subsystem to handle safety management for automotive, robotics, and/or other applications. The safety processor(s) 713—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 713 may include a discrete processor(s), such that fault of other system components may not impact the performance and availability of the safety processor 713.

The processor(s) 710 may further include a real-time or near real-time sensor engine (SE) 759 that may include a dedicated processor subsystem for handling real-time or near real-time camera, LiDAR, RADAR, and/or other sensor modality management.

The processor(s) 710 may further include one or more image signal processors (ISPs) 727, which may include a high-dynamic range signal processor and/or a hardware engine that is part of one or more sensor processing pipelines.

The processor(s) 710 may include a video image compositor (VIC) 761 that may be a processing block (e.g., implemented on a microprocessor) that implements video post-processing functions needed by a video playback application to produce the final image for the player window. The VIC 761 may perform lens distortion correction on wide-view camera(s) 768B, surround camera(s) 768D, in-cabin monitoring camera sensors, and/or other camera sensors with distorted fields of view.

A VIC 761 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 761 may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a broad range of peripheral interfaces for input/output (I/O) 725, such as to enable communication with peripherals, audio codecs, power management, and/or other devices. The SoC(s) 704 may be used to process data from cameras (e.g., connected over Gigabit Multimedia Serial Link and/or Ethernet), sensors (e.g., LiDAR sensor(s) 764, RADAR sensor(s) 760, etc. that may be connected over Ethernet), data from bus 702 (e.g., speed of machine 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks. In some embodiments, the SoC(s) 704 I/O 725 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 725 elements, components, or features.

The SoC(s) 704 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 704 may include an RJ45 connector with up to 10 GbE, a 1 GbE connector, and/or other networking connector types.

The SoC(s) 104 may include one or more digital signal processors (DSPs) 743. For example, the DSP(s) 743 may include a dedicated or specialized microprocessor chip optimized for digital signal processing-such as in audio signal processing, telecommunications, digital image processing, RADAR, SONAR, LiDAR, and/or other sensor processing, speech recognition, and/or other applications.

The SoC(s) 704 may include one or more video encoders 719 and/or one or more video decoders 721. For example, the video encoder(s) 719 may include a hardware-based (e.g., as part of the GPU(s) 708) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 721 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 721 may be hardware-based (e.g., as part of the GPU(s) 708).

The SoC(s) 704 may include one or more general compute acceleration clusters (GCAC(s)) 729. For example, the GCAC(s) 729 may include various processor types that may be used to accelerate compute, such as one or more vector microcode processors (VMPs) 733, one or more multi-threaded processing clusters (MPCs) 731, one or more programmable macro arrays (PMA(s)) 735, and/or one or more other processor types. For example, the GCAC(s) 729 may include a PMA 735, two VMPs 733, and 2 MPCs 731.

The SoC(s) 704 may include one or more vector microcode processors (VMPs) 733. The VMP(s) 733, in embodiments, may include a wide vector (very long instruction word (VLIW) and single instruction multiple data (SIMD)) machine with performing various operations, such as short integral type operations common in computer vision and deep learning algorithms.

The SoC(s) 704 may include one or more multi-threaded processing clusters (MPCs) 731. The MPC(s) 731 may include a processing cluster that be, in embodiments, more versatile than a GPU, and with higher efficiency than a CPU. For example, the MPC(s) 731 may include a multi-threaded processor that allows multiple threads to share resources and execute instructions concurrently.

The SoC(s) 704 may include one or more programmable macro arrays (PMA(s)) 735. The PMA(s) 735 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 704 may include one or more display processing units (DPUs) 745 for performing hardware-accelerated image processing. For example, the DPU(s) 745 may retrieve pixel data from memory 715 and send it to a display peripheral through standard interfaces. As such, the DPU(s) 745 may handle display processing and rendering for in-machine and/or on-machine displays.

The SoC(s) 704 may include one or more application processing units (APUs) 739. For example, the APU(s) 739 may include a quad or dual-core processor with 48 KB/32 KB L1 cache with parity and ECC, along with a 1 MB L2 cache with ECC. The APU(s) 739 may support NEON instructions and single and double precision floating point operations.

The SoC(s) 704 may include one or more real-time processing units (RTPUs) 769. The RTPU(s) 769 may include a dual-core processor with 32 KB/32 KB L1 cache, and 256 KB TCM with ECC. The RTPU(s) 769 may support single and double precision floating point operations.

The SoC(s) 704 may include one or more built-in self-test (BIST) components 737. For example, the BIST component(s) 737 may include memory BIST (MBIST) to test memories of the system and/or logic BIST (LBIST) to test logic of the system. The BIST components 737 may include embedded logic for directly testing logic and/or memory of the system.

The SoC(s) 704 may include one or more dynamically reconfigurable processors (DRPs) 771. For example, the DRP(s) 771 may be used for accelerating various computing operations. For example, the DRP(s) 771 may be combined, in embodiments, with a MAC unit for use as an AI accelerator. In embodiments, the DRP(s) 771 may execute applications while dynamically switching the circuit connection configuration of the arithmetic units (e.g., ALUs) on the chip at each operating clock according to the content to be processed. Since only the necessary arithmetic circuits are used, the DRP(s) 771 may consume less power than with CPU processing and can achieve higher speed. Furthermore, compared to CPUs, where frequent external memory accesses due to cache misses and other causes will degrade performance, the DRP(s) 771 can build the necessary data paths in hardware ahead of time, resulting in less performance degradation and less variation in operating speed (jitter) due to memory accesses. The DRP(s) 771 may include a dynamic loading function that switches the circuit connection information each time the algorithm changes, enabling processing with limited hardware resources, even in robotic/automotive applications that require processing of multiple algorithms.

In some embodiments, the accelerator(s) 714 may include an OpenCV accelerator for speeding up processing of OpenCV, an open-source industry standard library for computer vision processing. In some embodiments, the combination of one or more DRP(s) 771 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 704 may include various compute engines (e.g., processors 710, CPUs 706, GPU(s) 708, accelerator(s) 714, etc.), tasks may be distributed between and among the compute engines, in some instances without common cause failures due to the discrete footprint of the compute engines. Further, because the SoC(s) 704 may include a dedicated safety processor(s) 713 (or safety island 713), critical safety or redundant operations may be performed without common cause failures from the main processing components or compute engines of the SoC(s) 714. Due to these features, the SoC(s) 704 and/or the underlying systems of the machine 700 may be capable of satisfying higher levels of safety-such as automotive safety integrity level (ASIL) D from the ISO 26262 standard.

FIG. 7E is a system diagram for communication between a cloud-based server(s) (e.g., in a data center, such as those described herein) and the example autonomous or semi-autonomous vehicle or machine 700 of FIG. 7A, in accordance with some embodiments of the present disclosure. The system 776 may include a server(s) 778, a network(s) 790, and a machine(s) 700. The server(s) 778 may include a plurality of GPUs 784(A)-784(H) (collectively referred to herein as GPUs 784), switches 782(A)-782(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 780(A)-780(B) (collectively referred to herein as CPUs 780), accelerators, and/or other processor types. The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the machine(s) 700, sensor data indicating information about new or previously unexplored locations, and/or sensor data indicating changes to previously seen/stored locations (e.g., unexpected or changed road conditions, such as recently commenced road-work). The server(s) 778 may transmit, over the network(s) 790 and to the machine(s) 700, neural networks 792, updated neural networks 792, map information 794, etc., including information regarding traffic and road conditions. The updates to the map information 794 may include updates for the HD map 722, SD map, navigation map, etc., such as information regarding construction sites, potholes, detours, flooding, and/or other obstructions. In some examples, the neural networks 792, the updated neural networks 792, the map information 794, and/or the other information may have resulted from new training and/or experiences represented in data received from any number of machine(s) 700 in the environment, and/or based on training performed at a datacenter (e.g., using the server(s) 778 and/or other servers).

The server(s) 778 may be used to train machine learning models (e.g., neural networks) based on training data. The training data may be generated by the machine(s) 700, and/or may be generated in a simulation (e.g., using a game engine). In some examples, the training data is tagged (e.g., where the neural network benefits from supervised learning) and/or undergoes other pre-processing, while in other examples the training data is not tagged and/or preprocessed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 700 (e.g., transmitted to the machine(s) 700 over the network(s) 790, and/or the machine learning models may be used by the server(s) 778 to remotely monitor and/or control the machine(s) 700.

In some examples, the server(s) 778 may receive data from the machine(s) 700 and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the machine 700. For example, the deep-learning infrastructure may receive periodic updates from the machine 700, such as a sequence of images and/or objects that the machine 700 has located in that sequence of images (e.g., via computer vision and/or other machine learning object classification techniques). The deep-learning infrastructure may run its own neural network to identify the objects and compare them with the objects identified by the machine 700 and, if the results do not match and the infrastructure concludes that the AI in the machine 700 is malfunctioning, the server(s) 778 may transmit a signal to the machine 700 instructing a fail-safe computer of the machine 700 to assume control, notify the passengers, and complete a safety maneuver or operation-such as to slow down, hand control back to a driver, come to a stop, and/or pull over/shut down.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 8 is a system diagram illustrating a three computer ecosystem 800, including a first computing system 802 for generating or creating artificial intelligence (AI)—such as AI training and validation data, a second computing system 804 for training artificial intelligence, and a third computing system 806 (which may include or correspond to the SoC(s) 704 of FIGS. 7A-7E) deploying the AI at the edge, in accordance with at least some embodiments of the present disclosure. For example, to develop and deploy embodied or physical AI, the three computer ecosystem 800 may be used, including three accelerated computer systems to handle physical AI training, simulation, and runtime (e.g., edge deployment). These systems may generate training data for and train multimodal foundation models (and/or other model types) using scalable, physically based simulations of the machine(s) 700 and their worlds. By doing so, simulation of machine(s) 700 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 700 can perform safely in controlled settings.

The computing system 804 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 700 to understand natural language and emulate movements by observing human actions. The computing system 804 may include a platform that incorporates software, infrastructure, and expertise in a modern, unified AI development and training solution. The computing system 804 may include individual computing devices 810 (e.g., NVIDIA's DGX B200, H200, etc.) and/or any number of computing devices 810 in a data center infrastructure 812 (e.g., NVIDIA's DGX SuperPOD).

For example, the individual computing devices 810 may include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 810 may include memory (e.g., 4 TB memory, and storage (e.g., OS storage of 2×1.9 TB NVMe M.2, and internal storage of 8×3.84 TB NVMe U.2). The computing devices 810 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 810 may further include, e.g., dual port quad small form-factor pluggable (QSFFP) data processing units (DPUs) (e.g., 2 dual-port QSFP112 DPUs-such as NVIDIA's BlueField-3 DPUs), providing up to 400 Gb/s InfiniBand/Ethernet. The computing device(s) 810 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 810 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 810 may include a smart host channel adapter (HCA) (e.g., NVIDIA's ConnectX-7) to provide ultra-low latency, 400 Gb/s throughput for in-network computing acceleration engines.

The data center infrastructure 812 may include any number of the computing devices 810, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 810) to thousands, job scheduling and orchestration to ensure hassle-free execution of every developer's job, AI workflow management and machine learning operations (MLOps) to move more models from prototype to production, and enterprise software to speed developer success.

The computing system 802 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 802 allows developers to use simulation frameworks to simulate and validate robot models, and/or to generate massive amounts of physically-based synthetic data to bootstrap model training. The computing system 802 may support learning frameworks that power robot reinforcement learning and imitation learning, to accelerate robot policy training and refinement. For example, the computing system 802 may be used to generate any number of simulations 808—such as within NVIDIA's OMNIVERSE. The computing system 802 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 802 may host or support a native OpenUSD software platform enabling enterprises to connect 3D pipelines and develop advanced, real-time 3D applications for industrial digitalization. With powerful ray-tracing-accelerated AI and graphics capabilities, the computing system 802 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 802 may include individual computing devices 814 (e.g., NVIDIA's OVX L40S Server) and/or any number of computing devices 814 in a data center infrastructure 816 (e.g., NVIDIA's OVX Systems).

The computing device(s) 814 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 814 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 814 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 814 may include a smart host channel adapter (HCA) (e.g., NVIDIA's ConnectX-7) to provide ultra-low latency, 400 Gb/s throughput for in-network computing acceleration engines. The computing device(s) 814 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 812, the data center infrastructure 816 may allow for any number of computing device(s) 814 to be combined in cluster configuration according to a reference architecture.

The computing system 806 may be used to deploy trained AI models on a runtime computer-such as the SoC(s) 704 described herein. For example, these computing systems 806 may be designed for compact, on-board computing needs, including an ensemble of models for control policy, vision and language models, etc., deployed on a power-efficient on-board edge computing system 806. Details of components, features, and capabilities of the computing system 806 may be described in more detail herein with respect to FIGS. 7A-7E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation.

LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model or version, instance, or agent—may be be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9 is a block diagram of an example generative language model system 900 suitable for use in implementing at least some embodiments of the present disclosure. In the example illustrated in FIG. 9, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a MMLM, a VLA model, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization (TN), for example, by converting all characters to lowercase, removing accents, and/or or handling special cases like contractions or abbreviations to ensure consistency (e.g., converting ¼ to one quarter). Similarly, the input processor 905 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant-such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history- or at least a summary thereof- and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features-such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use- or capable of accessing or using-plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources-such as the plug-ins/APIs 995.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s), speaker(s), etc.), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

At least one aspect relates to one or more processors. The one or more processors can include one or more circuits. The one or more circuits can initialize a simulation comprising a simulated robot and a simulated object. The one or more circuits can update a teacher model to generate first actions for a geometric fabric associated with the simulated robot using state information of the simulation and position information of the object. The one or more circuits can update, using the teacher model and a depth image of the simulation, a student model to generate second actions for the geometric fabric associated with the simulated robot. The one or more circuits can provide a depth image of an environment as input to the student model to predict at least one action to control a physical robot with respect to a physical object using the geometric fabric.

In some implementations, the one or more circuits can update the teacher model further based at least on one or more of simulated proprioception data of the robot in the simulation, a goal position for the object within the simulation, or simulated forces. In some implementations, the one or more circuits can execute the simulation at a first update frequency. In some implementations, the one or more circuits can execute the teacher model to generate the first actions for the geometric fabric at a second update frequency. In some implementations, the one or more circuits can generate a control instruction for the robot by providing the at least one action as input to the geometric fabric. In some implementations, the one or more circuits can generate the control instruction based at least on a state machine.

In some implementations, the one or more circuits can update the student model based at least on a loss determined according to an output of the student model, an output of the teacher model, and state data of the simulation. In some implementations, the one or more circuits can update the teacher model further based at least on an output of a critic model generated using the state information of the simulation. In some implementations, the student model comprises one or more convolutional layers and one or more recurrent neural network (RNN) layers.

In some implementations, the one or more processors can execute a plurality of simulations each comprising a respective simulated robot and a respective simulated object. In some implementations, the student model comprises one or more transformer layers. In some implementations, the student model comprises at least one RNN layer and at least one fully-connected layer. In some implementations, the one or more circuits can generate, during the second update phase, an auxiliary loss based at least on a predicted position of a simulated object generated by the student model and a ground-truth object position derived from the simulation.

At least one aspect relates to a system. The system can include a robot configured to operate in response to control instructions from a geometric fabric controller. The system can include one or more processors. The system can provide a depth image of an environment including the robot and a physical object as input to a machine-learning model to generate at least one action. The system can generate a set of control instructions for the robot using the geometric fabric controller and based at least on the action. The system can control the robot using the set of control signals to grasp the object.

In some implementations, the system can generate an output action by providing the at least one action as input to a state machine. In some implementations, the system can generate the set of control signals based at least on providing the output action as input to the geometric fabric. In some implementations, the system can provide a set of proprioception data and the depth image as input to the machine-learning model to generate the at least one action. In some implementations, the system can provide an indication of a goal position as input to the machine-learning model. In some implementations, the system can generate, using the machine-learning model, an indication of a predicted position of the object. In some implementations, the system can generate the set of control instructions further based on the predicted position of the object.

At least one other aspect relates to a method. The method can be performed, for example, by one or more processors coupled to non-transitory memory. The method can include initializing a simulation comprising a simulated robot and a simulated object. The method can include updating a teacher model to generate first actions for a geometric fabric associated with the simulated robot using state information of the simulation and position information of the object. The method can include updating, using the teacher model and a depth image of the simulation, a student model to generate second actions for the geometric fabric associated with the simulated robot. The method can include providing a depth image of an environment as input to the student model to predict at least one action to control a physical robot with respect to a physical object using the geometric fabric.

In some implementations, the method can include updating the teacher model further based at least on one or more of simulated proprioception data of the robot in the simulation, a goal position for the object within the simulation, or simulated forces. In some implementations, the method can include executing the simulation at a first update frequency. In some implementations, the method can include executing the teacher model to generate the first actions for the geometric fabric at a second update frequency. In some implementations, the method can include generating a control instruction for the robot by providing the at least one action as input to the geometric fabric.

At least one aspect relates to one or more processors. The one or more processors can include one or more circuits. The one or more circuits can update, during a first update stage, a teacher model to generate first actions for a geometric fabric associated with a simulated robot of a simulation using state information of the simulation. The one or more circuits can update, during a second update stage, a student model to generate second actions for the geometric fabric using at least one rendered image of the simulation, the teacher model, and noised state information of the simulation. The one or more circuits can control, using the student model and the geometric fabric, a physical robot with respect to a physical object based at least on an image of an environment including the physical robot and the physical object.

In some implementations, the student model comprises one or more transformer layers. In some implementations, the student model comprises at least one RNN layer and at least one fully-connected layer. In some implementations, the one or more circuits can generate, during the second update phase, an auxiliary loss based at least on a predicted position of a simulated object generated by the student model and a ground-truth object position derived from the simulation. In some implementations, the one or more circuits can generate a loss for updating the student model based at least on the auxiliary loss and a second loss generated using an output of the teacher model.

In some implementations, the one or more circuits can update the student model further based on proprioception data derived from the simulation. In some implementations, the one or more circuits can execute the simulation at a frequency of about 120 Hertz. In some implementations, the one or more circuits can update the teacher model according to an automatic domain randomization function. In some implementations, the one or more circuits can modify lighting or materials of the simulation during the second update stage. In some implementations, the one or more circuits can update, during the second update stage, the student model to generate second actions for the geometric fabric using a plurality of rendered images of the simulation.

At least one aspect relates to a system. The system can include a robot configured to operate in response to control instructions from a geometric fabric controller. The system can include one or more processors. The system can capture at least two color-based images of an environment including the robot and a physical object. The system can provide the at least two color-based images as input to a machine-learning model comprising an encoder to implement cross-attention masking between the at least two color-based images, the machine-learning model generating at least one action for the robot. The system can control the robot with respect to the physical object using the action and a geometric fabric controller.

In some implementations, the machine-learning model is to generate a predicted position of the object, and the system can control the robot further based on the predicted position of the object. In some implementations, the system can control the robot further based on an output of a state machine. In some implementations, the system can provide a set of proprioception data and the at least two color-based images as input to the machine-learning model to generate the at least one action. In some implementations, the machine-learning model further comprises at least one RNN layer and at least one fully connected layer.

At least one other aspect relates to a method. The method can be performed, for example, by one or more processors coupled to non-transitory memory. The method can include updating, during a first update stage, a teacher model to generate first actions for a geometric fabric associated with a simulated robot of a simulation using state information of the simulation. The method can include updating, during a second update stage, a student model to generate second actions for the geometric fabric using at least one rendered image of the simulation, the teacher model, and noised state information of the simulation. The method can further include controlling, using the student model and the geometric fabric, a physical robot with respect to a physical object based at least on an image of an environment including the physical robot and the physical object.

In some implementations, the student model comprises one or more transformer layers. In some implementations, the student model comprises at least one RNN layer and at least one fully-connected layer.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
cause a teacher model to generate first actions for a geometric fabric associated with a simulated autonomous machine in a simulated environment using state information of the simulated environment and position information of a simulated object in the simulated environment;
update, using the teacher model and a depth image of the simulated environment, a student model to generate second actions for the geometric fabric associated with the simulated autonomous machine; and
provide a depth image of an environment as input to the student model to cause the student model to infer at least one action to control a physical autonomous machine with respect to a physical object using the geometric fabric.

2. The one or more processors of claim 1, wherein the one or more circuits are to:
update the teacher model further based at least on at least one of simulated proprioception data of the autonomous machine in the simulated environment, a goal position for the object within the simulated environment, or one or more simulated forces applicable to the simulated environment.

3. The one or more processors of claim 1, wherein the one or more circuits are to:
execute the simulated environment at a first update frequency; and
execute the teacher model to generate the first actions for the geometric fabric at a second update frequency.

4. The one or more processors of claim 1, wherein the one or more circuits are to:
generate a control instruction for the physical autonomous machine by providing the at least one action as input to the geometric fabric.

5. The one or more processors of claim 4, wherein the one or more circuits are to:
generate the control instruction based at least on a state machine.

6. The one or more processors of claim 1, wherein the one or more circuits are to:
update the student model based at least on a loss determined according to an output of the student model, an output of the teacher model, and state data of the simulated environment.

7. The one or more processors of claim 1, wherein the one or more circuits are to:
update the teacher model further based at least on an output of a critic model generated using the state information of the simulated environment.

8. The one or more processors of claim 1, wherein the student model comprises one or more convolutional layers and one or more recurrent neural network (RNN) layers.

9. The one or more processors of claim 1, wherein the one or more processors are to:
execute a plurality of simulations of a plurality of simulated environments, each simulation comprising a respective simulated autonomous machine and a respective simulated object.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

11. A system, comprising:
an autonomous machine to operate in response to control instructions from a controller based on a geometric fabric; and
one or more processors to:
provide a depth image of an environment including the autonomous machine and a physical object as input to a machine-learning model to generate at least one action;
generate a set of control instructions for the autonomous machine using the controller and based at least on the at least one action; and
control the autonomous machine using the set of control instructions to grasp the object.

12. The system of claim 11, wherein the one or more processors are to:
generate an output action by providing the at least one action as input to a state machine; and
generate the set of control instructions based at least on providing the output action as input to the geometric fabric.

13. The system of claim 11, wherein the one or more processors are to:
provide a set of proprioception data and the depth image as input to the machine-learning model to generate the at least one action.

14. The system of claim 13, wherein the one or more processors are to:
provide an indication of a goal position as input to the machine-learning model.

15. The system of claim 11, wherein the one or more processors are to:
generate, using the machine-learning model, an indication of a predicted position of the object; and
generate the set of control instructions further based at least on the predicted position of the object.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

17. A method, comprising:
updating, using one or more processors, a teacher model to generate first actions for a geometric fabric associated with a simulated autonomous machine of a simulation using state information of the simulation and position information of a simulated object in the simulation;
updating, using one or more processors, using the teacher model and a depth image of the simulation, a student model to generate second actions for the geometric fabric associated with the simulated autonomous machine; and
providing, using one or more processors, a depth image of an environment as input to the student model to infer at least one action to control a physical autonomous machine with respect to a physical object using the geometric fabric.

18. The method of claim 17, further comprising:
updating, using the one or more processors, the teacher model further based at least on one or more of simulated proprioception data of the simulated autonomous machine in the simulation, a goal position for the object within the simulation, or simulated forces.

19. The method of claim 17, further comprising:
executing, using the one or more processors, the simulation at a first update frequency; and
executing, using the one or more processors, the teacher model to generate the first actions for the geometric fabric at a second update frequency.

20. The method of claim 17, further comprising:
generating, using the one or more processors, a control instruction for the physical autonomous machine by providing the at least one action as input to the geometric fabric.
